(19) United States
(12) Patent Application Publication
(10) Pub. No.: US 2017/0064073 A1
(43) Pub. Date: Mar. 2, 2017

(54) CONTROLLING ONE OR MORE PROXIMATE DEVICES VIA A MOBILE DEVICE BASED ON ONE OR MORE DETECTED USER ACTIONS WHILE THE MOBILE DEVICE OPERATES IN A LOW POWER MODE

(71) Applicant: QUALCOMM Incorporated, San Diego, CA (US)

(72) Inventors: Brian SPENCER, San Diego, CA (US); Mitchell WILLIAMS, JR., San Diego, CA (US)

(21) Appl. No.: 15/204,278

(22) Filed: Jul. 7, 2016

Related U.S. Application Data
(60) Provisional application No. 62/212,968, filed on Sep. 1, 2015.
(60) Provisional application No. 62/265,756, filed on Dec. 10, 2015.

(51) Int. Cl. H04M 1/725; H04W 4/02; H04W 52/02

(52) U.S. Cl. CPC H04M 1/72577; H04W 52/0254; H04M 1/72569; H04M 1/72572; H04M 1/7253; H04W 4/023

(57) ABSTRACT

In an embodiment, a mobile device is equipped with an application processor configured to execute a HLOS and a secondary processor(s) configured to control sensor(s) coupled to the mobile device. The mobile device monitors the sensor(s) while the mobile device is operating in a low power mode that is characterized by one or more cores of the application processor being in a power collapse state or dormant state. The mobile device identifies a user action based on the monitoring and communicates, while the mobile device continues to operate in the low power mode, with detected proximate device(s) over a local wireless communications interface to request that at least one device action changing a user interface output feature and/or a user environment feature be implemented at the detected proximate device(s).

### CROSS-REFERENCE TO RELATED APPLICATIONS

The present application for patent claims the benefit of U.S. Provisional Application No. 62/212,968, entitled “CONTROLLING ONE OR MORE PROXIMATE DEVICES VIA A MOBILE DEVICE BASED ON ONE OR MORE DETECTED USER ACTIONS WHILE THE MOBILE DEVICE OPERATES IN A LOW POWER MODE”, filed Sep. 1, 2015, and U.S. Provisional Application No. 62/265,756, entitled “CONTROLLING ONE OR MORE PROXIMATE DEVICES VIA A MOBILE DEVICE BASED ON ONE OR MORE DETECTED USER ACTIONS WHILE THE MOBILE DEVICE OPERATES IN A LOW POWER MODE”, filed Dec. 10, 2015, each of which is by the same inventors as the subject application, assigned to the assignee hereof and hereby expressly incorporated by reference herein in its entirety.

### FIELD

This disclosure relates to controlling one or more proximate devices via a mobile device based on one or more detected user actions while the mobile device operates in a low power mode.

### BACKGROUND

Mobile devices (e.g., cellular phones, tablet computers, laptop computers, etc.) can be used to control proximate devices, such as Internet of Things (IoT) devices over an IoT network. For example, in an IoT-specific example, mobile devices can adjust light output by one or more proximate IoT light bulbs, speaker output by one or more proximate IoT speakers (or an IoT receiver controlling one or more speakers coupled thereto), and so on. Generally, to control proximate devices, a mobile device is required to enter into a high-power mode of operation. For example, if the mobile device is in a low power mode (e.g., sleep mode, etc.), a user may be required to unlock the mobile device in order to enter a high power mode or active mode, navigate to a control application that is configured to control the proximate devices, launch the control application, authenticate him/herself with the control application as having sufficient privileges for controlling the proximate devices, and only at this point is the user in a position to manipulate the control application in order to implement any desired changes with respect to operation of the proximate devices. Accordingly, there are typically multiple steps that the user must make with respect to the mobile device before being able to control the proximate devices.

### SUMMARY

In an embodiment, a mobile device is equipped with an application processor configured to execute a High Level Operating System (HLOS) of the mobile device and a set of secondary processors configured to control a set of sensors coupled to the mobile device. The mobile device monitors the set of sensors while the mobile device is operating in a low power mode that is characterized by one or more cores of the application processor being in a power collapse state or dormant state. The mobile device identifies a user action based on the monitoring. The mobile device maps the user action to a set of device actions to be implemented at a set of devices, detects that at least one device from the set of devices is currently proximate to the mobile device and communicates, in response to the detecting while the mobile device continues to operate in the low power mode, with the detected at least one proximate device over a local wireless communications interface to request that at least one device action from the set of device actions changes a user interface output feature and/or a user environment feature be implemented at the detected at least one proximate device.

### BRIEF DESCRIPTION OF THE DRAWINGS

A more complete appreciation of aspects of the disclosure and many of the attendant advantages thereof will be readily obtained as the same becomes better understood by reference to the following detailed description when considered in connection with the accompanying drawings which are presented solely for illustration and not limitation of the disclosure, and in which:

FIG. 1A illustrates a high-level system architecture of a wireless communications system in accordance with an aspect of the disclosure.

FIG. 1B illustrates a high-level system architecture of a wireless communications system in accordance with another aspect of the disclosure.

FIG. 1C illustrates a high-level system architecture of a wireless communications system in accordance with an aspect of the disclosure.

FIG. 1D illustrates a high-level system architecture of a wireless communications system in accordance with an aspect of the disclosure.

FIG. 1E illustrates a high-level system architecture of a wireless communications system in accordance with an aspect of the disclosure.

FIG. 2A illustrates an exemplary Internet of Things (IoT) device in accordance with aspects of the disclosure.

FIG. 2B illustrates an exemplary passive IoT device in accordance with aspects of the disclosure.

FIG. 3 illustrates a communication device that includes structural components configured to perform functionality in accordance with an aspect of the disclosure.

FIG. 4 illustrates an exemplary server according to various aspects of the disclosure.

FIG. 5 illustrates a mobile device in accordance with an embodiment of the disclosure.

FIG. 6A illustrates hardware from FIG. 5 that is unavailable during the low power mode in accordance with an embodiment of the disclosure.

FIG. 6B illustrates hardware from FIG. 5 that is optionally available during the low power mode in accordance with an embodiment of the disclosure.

FIG. 6C illustrates hardware from FIG. 5 that is available during the low power mode in accordance with an embodiment of the disclosure.

FIG. 7A illustrates a configuration procedure by which user actions (or triggers) that are detectable at a mobile device are mapped to device actions to be implemented at one or more proximate devices relative to the mobile device in accordance with an embodiment of the disclosure.

FIG. 7B illustrates an example of a discovery procedure performed by the secondary processors 1 . . . N that can trigger execution of the process of FIG. 7A in accordance with an embodiment of the disclosure.

FIG. 8 illustrates a conference room that is described with respect to the process of FIG. 7A in accordance with an embodiment of the disclosure.

FIGS. 9A-9H illustrate screens that are presented to a user during the process of FIG. 7A in accordance with an embodiment of the disclosure.

FIGS. 9I-9J illustrate screens that are presented to a user during the process of FIG. 7B in accordance with an embodiment of the disclosure.

FIG. 10 illustrates a process of implementing at least one device action at a set of proximate devices in response to a detected user action in accordance with an embodiment of the disclosure.

FIG. 11 illustrates an example continuation of the process of FIG. 10 in accordance with an embodiment of the disclosure.

FIGS. 12A-12B illustrate an example of a user action that is mapped to one or more device actions in accordance with an embodiment of the disclosure.

FIGS. 13A-13B illustrate another example of a user action that is mapped to one or more device actions in accordance with an embodiment of the disclosure.

FIGS. 14A-14B illustrate another example of a user action that is mapped to one or more device actions in accordance with an embodiment of the disclosure.

FIGS. 15A-15B illustrate another example of a user action that is mapped to one or more device actions in accordance with an embodiment of the disclosure.

FIGS. 16A and 16C illustrate another example of a user action that is mapped to one or more device actions in accordance with an embodiment of the disclosure.

FIG. 16B illustrates a bedroom that is described with respect to the processes of FIGS. 16A and 16C in accordance with an embodiment of the disclosure.

### DETAILED DESCRIPTION

Various aspects are disclosed in the following description and related drawings to show specific examples relating to exemplary embodiments of controlling one or more proximate devices via a mobile device based on one or more detected user actions while the mobile device operates in a low power mode. Alternate embodiments will be apparent to those skilled in the pertinent art upon reading this disclosure, and may be constructed and practiced without departing from the scope or spirit of the disclosure. Additionally, well-known elements will not be described in detail or may be omitted so as to not obscure the relevant details of the aspects and embodiments disclosed herein.

The word “exemplary” is used herein to mean “serving as an example, instance, or illustration.” Any embodiment described herein as “exemplary” is not necessarily to be construed as preferred or advantageous over other embodiments. Likewise, the term “embodiments” does not require that all embodiments include the discussed feature, advantage or mode of operation.

The terminology used herein describes particular embodiments only and should not be construed to limit any embodiments disclosed herein. As used herein, the singular forms “a,” “an,” and “the” are intended to include the plural forms as well, unless the context clearly indicates otherwise. It will be further understood that the terms “comprises,” “comprising,” “includes,” and/or “including,” when used herein, specify the presence of stated features, integers, steps, operations, elements, and/or components, but do not preclude the presence or addition of one or more other features, integers, steps, operations, elements, components, and/or groups thereof.

Further, many aspects are described in terms of sequences of actions to be performed by, for example, elements of a computing device. It will be recognized that various actions described herein can be performed by specific circuits (e.g., an application specific integrated circuit (ASIC)), by program instructions being executed by one or more processors, or by a combination of both. Additionally, these sequence of actions described herein can be considered to be embodied entirely within any form of computer-readable storage medium having stored therein a corresponding set of computer instructions that upon execution would cause an associated processor to perform the functionality described herein. Thus, the various aspects of the disclosure may be embodied in a number of different forms, all of which have been contemplated to be within the scope of the claimed subject matter. In addition, for each of the aspects described herein, the corresponding form of any such aspects may be described herein as, for example, “logic configured to” perform the described action.

As used herein, the term “Internet of Things device” (or “IoT device”) may refer to any object (e.g., an appliance, a sensor, etc.) that has an addressable interface (e.g., an Internet protocol (IP) address, a Bluetooth identifier (ID), a near-field communication (NFC) ID, etc.) and can transmit information to one or more other devices over a wired or wireless connection. An IoT device may have a passive communication interface, such as a quick response (QR) code, a radio-frequency identification (RFID) tag, an NFC tag, or the like, or an active communication interface, such as a modem, a transceiver, a transmitter-receiver, or the like. An IoT device can have a particular set of attributes (e.g., a device state or status, such as whether the IoT device is on or off, open or closed, idle or active, available for task execution or busy, and so on, a cooling or heating function, an environmental monitoring or recording function, a light-emitting function, a sound-emitting function, etc.) that can be embedded in and/or controlled/monitored by a central processing unit (CPU), microprocessor, ASIC, or the like, and configured for connection to an IoT network such as a local ad-hoc network or the Internet. For example, IoT devices may include, but are not limited to, refrigerators, toasters, ovens, microwaves, freezers, dishwashers, dishes, hand tools, clothes washers, clothes dryers, furnaces, air conditioners, thermostats, televisions, light fixtures, vacuum cleaners, sprinklers, electricity meters, gas meters, etc., so long as the devices are equipped with an addressable communications interface for communicating with the IoT network. IoT devices may also include cell phones, desktop computers, laptop computers, tablet computers, personal digital assistants (PDAs), etc. Accordingly, the IoT network may be comprised of a combination of “legacy” Internet-accessible devices (e.g., laptop or desktop computers, cell phones, etc.) in addition to devices that do not typically have Internet-connectivity (e.g., dishwashers, etc.).

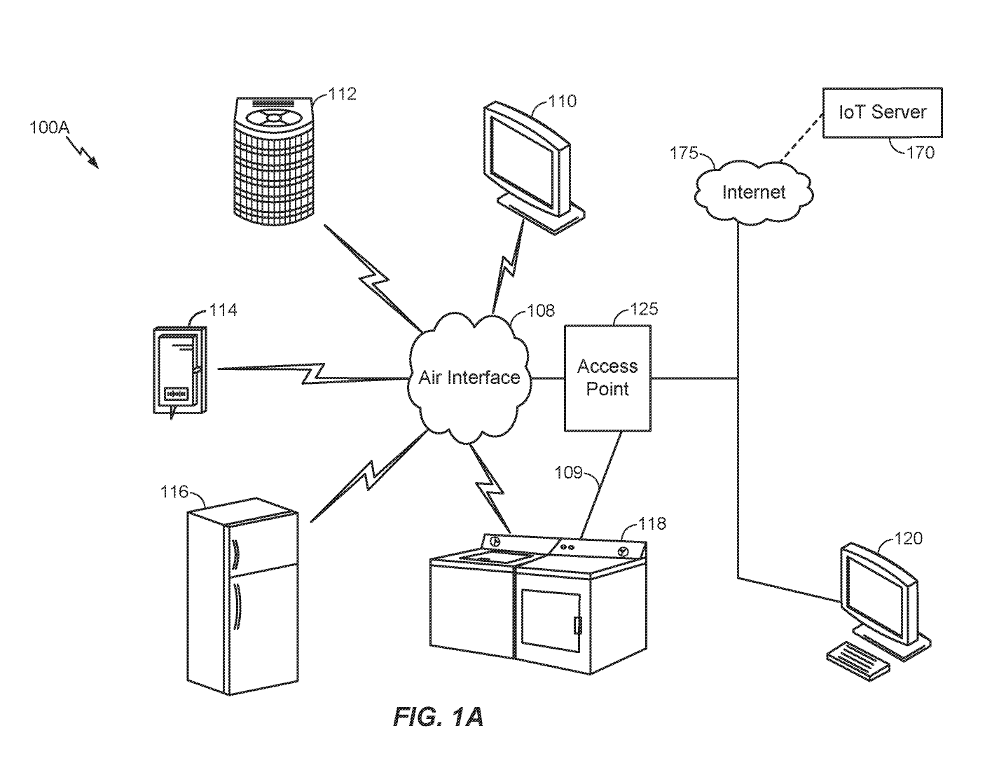

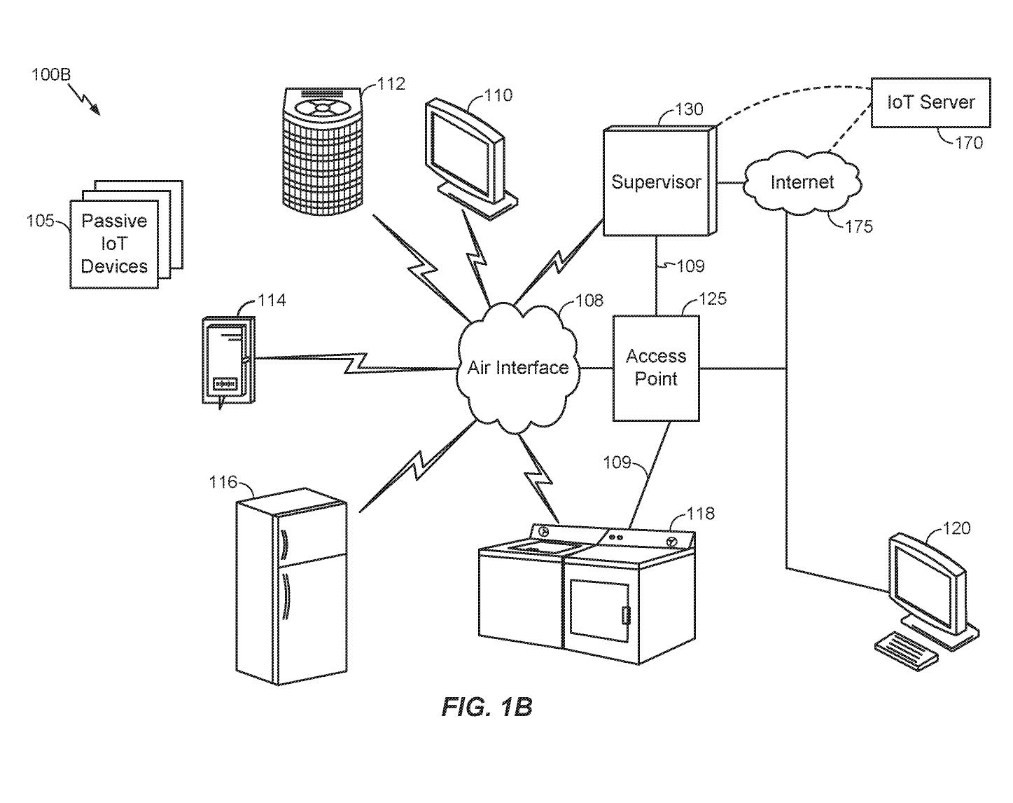

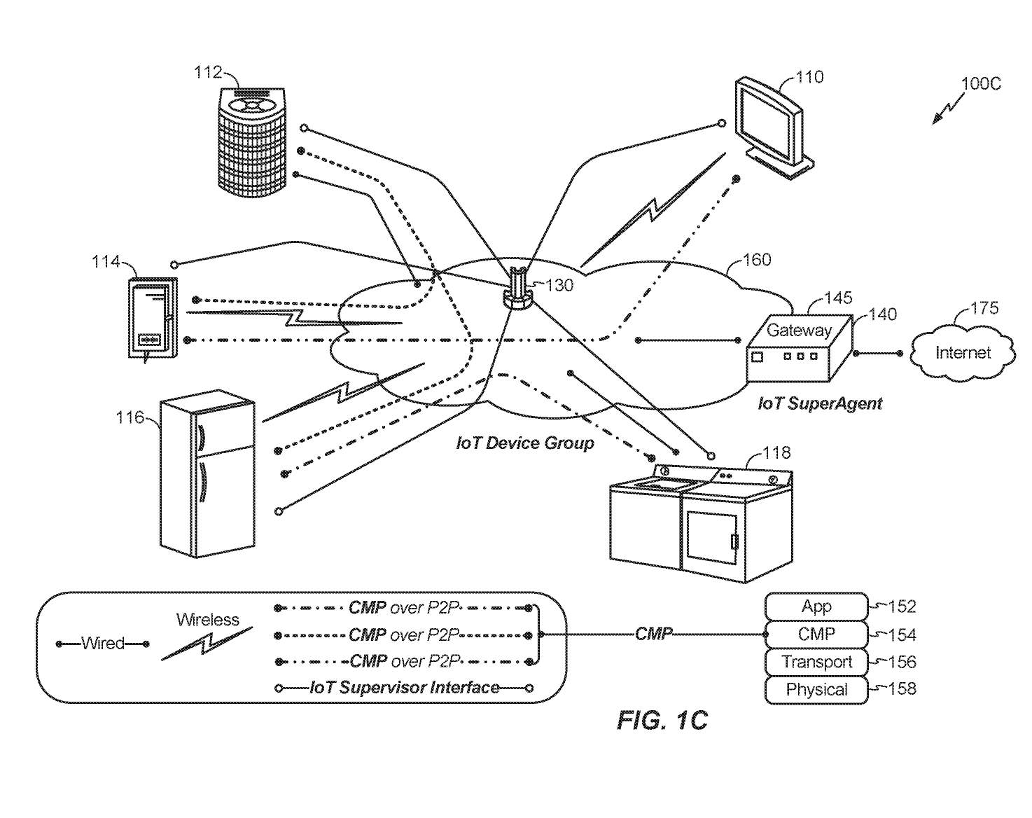

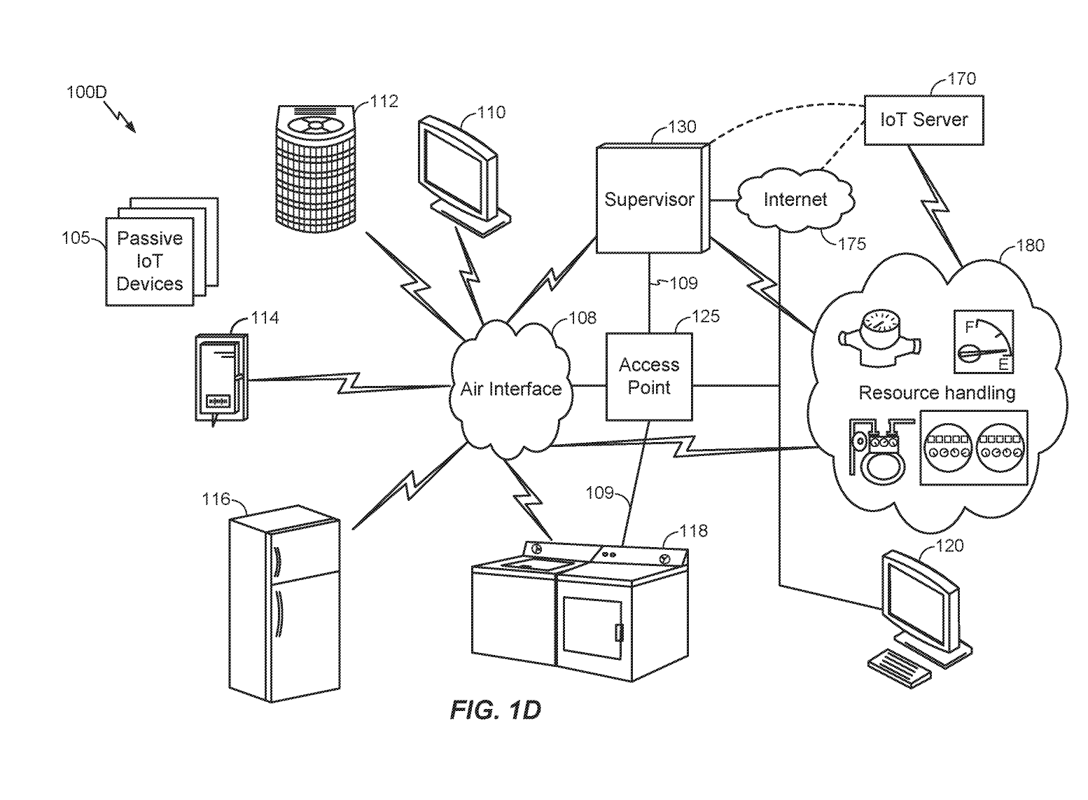

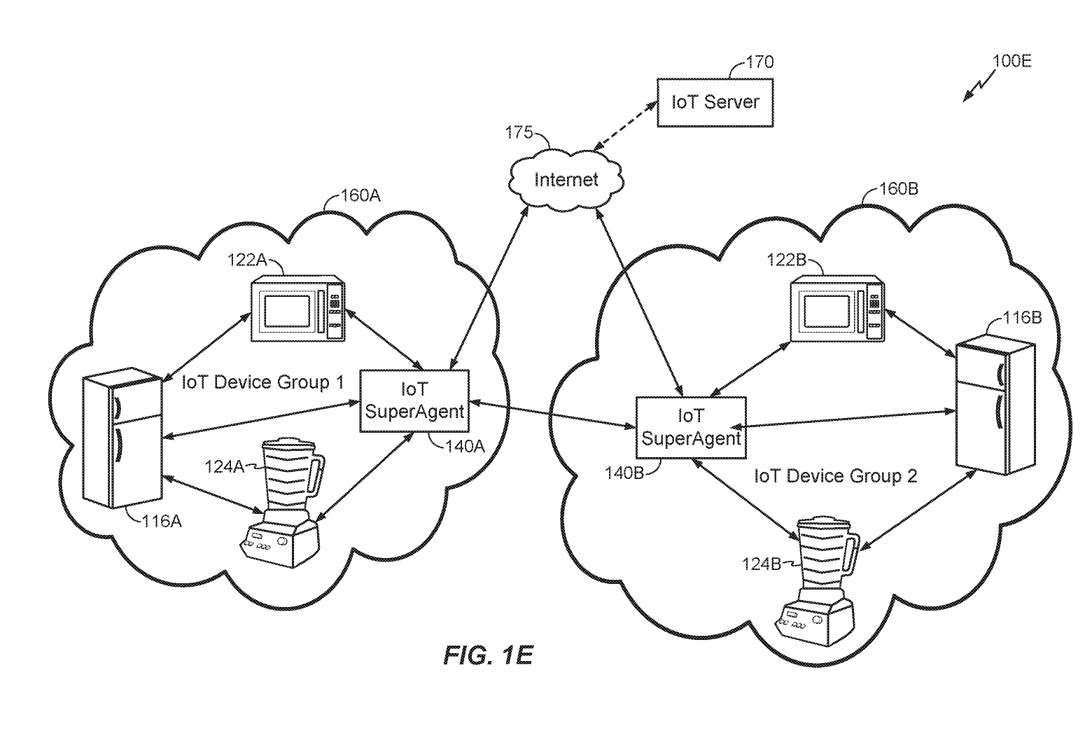

FIG. 1A illustrates a high-level system architecture of a wireless communications system 100A in accordance with an aspect of the disclosure. The wireless communications system 100A contains a plurality of IoT devices, which include a television 110, an outdoor air conditioning unit 112, a thermostat 114, a refrigerator 116, and a washer and dryer 118.

Referring to FIG. 1A, IoT devices 110-118 are configured to communicate with an access network (e.g., an access point 125) over a physical communications interface or layer, shown in FIG. 1A as air interface 108 and a direct wired connection 109. The air interface 108 can comply with a wireless Internet protocol (IP), such as IEEE 802.11. Although FIG. 1A illustrates IoT devices 110-118 communicating over the air interface 108 and IoT device 118 communicating over the direct wired connection 109, each IoT device may communicate over a wired or wireless connection, or both.

The Internet 175 includes a number of routing agents and processing agents (not shown in FIG. 1A for the sake of convenience). The Internet 175 is a global system of interconnected computers and computer networks that uses a standard Internet protocol suite (e.g., the Transmission Control Protocol (TCP) and IP) to communicate among disparate devices/networks. TCP/IP provides end-to-end connectivity specifying how data should be formatted, addressed, transmitted, routed and received at the destination.

In FIG. 1A, a computer 120, such as a desktop or personal computer (PC), is shown as connecting to the Internet 175 directly (e.g., over an Ethernet connection or WiFi or 802.11-based network). The computer 120 may have a wired connection to the Internet 175, such as a direct connection to a modem or router, which, in an example, can correspond to the access point 125 itself (e.g., for a WiFi router with both wired and wireless connectivity). Alternatively, rather than being connected to the access point 125 and the Internet 175 over a wired connection, the computer 120 may be connected to the access point 125 over air interface 108 or another wireless interface, and access the Internet 175 over the air interface 108. Although illustrated as a desktop computer, computer 120 may be a laptop computer, a tablet computer, a PDA, a smart phone, or the like. The computer 120 may be an IoT device and/or contain functionality to manage an IoT network/group, such as the network/group of IoT devices 110-118.

The access point 125 may be connected to the Internet 175 via, for example, an optical communication system, such as FiOS, a cable modem, a digital subscriber line (DSL) modem, or the like. The access point 125 may communicate with IoT devices 110-120 and the Internet 175 using the standard Internet protocols (e.g., TCP/IP).

Referring to FIG. 1A, an IoT server 170 is shown as connected to the Internet 175. The IoT server 170 can be implemented as a plurality of structurally separate servers, or alternately may correspond to a single server. In an aspect, the IoT server 170 is optional (as indicated by the dotted line), and the group of IoT devices 110-120 may be a peer-to-peer (P2P) network. In such a case, the IoT devices 110-120 can communicate with each other directly over the air interface 108 and/or the direct wired connection 109. Alternatively, or additionally, some or all of IoT devices 110-120 may be configured with a communication interface independent of air interface 108 and direct wired connection 109. For example, if the air interface 108 corresponds to a WiFi interface, one or more of the IoT devices 110-120 may have Bluetooth or NFC interfaces for communicating directly with each other or other Bluetooth or NFC-enabled devices.

In a peer-to-peer network, service discovery schemes can multicast the presence of nodes, their capabilities, and group membership. The peer-to-peer devices can establish associations and subsequent interactions based on this information.

In accordance with an aspect of the disclosure, FIG. 1B illustrates a high-level architecture of another wireless communications system 100B that contains a plurality of IoT devices. In general, the wireless communications system 100B shown in FIG. 1B may include various components that are the same and/or substantially similar to the wireless communications system 100A shown in FIG. 1A, which was described in greater detail above (e.g., various IoT devices, including a television 110, outdoor air conditioning unit 112, thermostat 114, refrigerator 116, and washer and dryer 118, that are configured to communicate with an access point 125 over an air interface 108 and/or a direct wired connection 109, a computer 120 that directly connects to the Internet 175 and/or connects to the Internet 175 through access point 125, and an IoT server 170 accessible via the Internet 175, etc.). As such, for brevity and ease of description, various details relating to certain components in the wireless communications system 100B shown in FIG. 1B may be omitted herein to the extent that the same or similar details have already been provided above in relation to the wireless communications system 100A illustrated in FIG. 1A.

Referring to FIG. 1B, the wireless communications system 100B may include a supervisor device 130, which may alternatively be referred to as an IoT manager 130 or IoT manager device 130. As such, where the following description uses the term “supervisor device” 130, those skilled in the art will appreciate that any references to an IoT manager, group owner, or similar terminology may refer to the supervisor device 130 or another physical or logical component that provides the same or substantially similar functionality.

In one embodiment, the supervisor device 130 may generally observe, monitor, control, or otherwise manage the various other components in the wireless communications system 100B. For example, the supervisor device 130 can communicate with an access network (e.g., access point 125) over air interface 108 and/or a direct wired connection 109 to monitor or manage attributes, activities, or other states associated with the various IoT devices 110-120 in the wireless communications system 100B. The supervisor device 130 may have a wired or wireless connection to the Internet 175 and optionally to the IoT server 170 (shown as a dotted line). The supervisor device 130 may obtain information from the Internet 175 and/or the IoT server 170 that can be used to further monitor or manage attributes, activities, or other states associated with the various IoT devices 110-120. The supervisor device 130 may be a standalone device or one of the IoT devices 110-120, such as computer 120. The supervisor device 130 may be a physical device or a software application running on a physical device. The supervisor device 130 may include a user interface that can output information relating to the monitored attributes, activities, or other states associated with the IoT devices 110-120 and receive input information to control or otherwise manage the attributes, activities, or other states associated therewith. Accordingly, the supervisor device 130 may generally include various components and support various wired and wireless communication interfaces to observe, monitor, control, or otherwise manage the various components in the wireless communications system 100B.

The wireless communications system 100B shown in FIG. 1B may include one or more passive IoT devices 105 (in contrast to the active IoT devices 110-120) that can be coupled to or otherwise made part of the wireless communications system 100B. In general, the passive IoT devices 105 may include barcoded devices, Bluetooth devices, radio frequency (RF) devices, RFID tagged devices, infrared (IR) devices, NFC tagged devices, or any other suitable device that can provide its identifier and attributes to another device when queried over a short range interface. Active IoT devices may detect, store, communicate, act on, and/or the like, changes in attributes of passive IoT devices.

For example, passive IoT devices 105 may include a coffee cup and a container of orange juice that each has an RFID tag or barcode. A cabinet IoT device and the refrigerator IoT device 116 may each have an appropriate scanner or reader that can read the RFID tag or barcode to detect when the coffee cup and/or the container of orange juice passive IoT devices 105 have been added or removed. In response to the cabinet IoT device detecting the removal of the coffee cup passive IoT device 105 and the refrigerator IoT device 116 detecting the removal of the container of orange juice passive IoT device 105, the supervisor device 130 may receive one or more signals that relate to the activities detected at the cabinet IoT device and the refrigerator IoT device 116. The supervisor device 130 may then infer that a user is drinking orange juice from the coffee cup and/or likes to drink orange juice from a coffee cup.

Although the foregoing describes the passive IoT devices 105 as having some form of RFID tag or barcode communication interface, the passive IoT devices 105 may include one or more devices or other physical objects that do not have such communication capabilities. For example, certain IoT devices may have appropriate scanner or reader mechanisms that can detect shapes, sizes, colors, and/or other observable features associated with the passive IoT devices 105 to identify the passive IoT devices 105. In this manner, any suitable physical object may communicate its identity and attributes and become part of the wireless communications system 100B and be observed, monitored, controlled, or otherwise managed with the supervisor device 130. Further, passive IoT devices 105 may be coupled to or otherwise made part of the wireless communications system 100A in FIG. 1A and observed, monitored, controlled, or otherwise managed in a substantially similar manner.

In accordance with another aspect of the disclosure, FIG. 1C illustrates a high-level architecture of another wireless communications system 100C that contains a plurality of IoT devices. In general, the wireless communications system 100C shown in FIG. 1C may include various components that are the same and/or substantially similar to the wireless communications systems 100A and 100B shown in FIGS. 1A and 1B, respectively, which were described in greater detail above. As such, for brevity and ease of description, various details relating to certain components in the wireless communications system 100C shown in FIG. 1C may be omitted herein to the extent that the same or similar details have already been provided above in relation to the wireless communications systems 100A and 100B illustrated in FIGS. 1A and 1B, respectively.

The wireless communications system 100C shown in FIG. 1C illustrates exemplary peer-to-peer communications between the IoT devices 110-118 and the supervisor device 130. As shown in FIG. 1C, the supervisor device 130 communicates with each of the IoT devices 110-118 over an IoT supervisor interface. Further, IoT devices 110 and 114, IoT devices 112, 114, and 116, and IoT devices 116 and 118, communicate directly with each other.

The IoT devices 110-118 make up an IoT device group 160. An IoT device group 160 is a group of locally connected IoT devices, such as the IoT devices connected to a user's home network. Although not shown, multiple IoT device groups may be connected to and/or communicate with each other via an IoT SuperAgent 140 connected to the Internet 175. At a high level, the supervisor device 130 manages intra-group communications, while the IoT SuperAgent 140 can manage inter-group communications. Although shown as separate devices, the supervisor device 130 and the IoT SuperAgent 140 may be, or reside on, the same device (e.g., a standalone device or an IoT device, such as computer 120 in FIG. 1A). Alternatively, the IoT SuperAgent 140 may correspond to or include the functionality of the access point 125. As yet another alternative, the IoT SuperAgent 140 may correspond to or include the functionality of an IoT server, such as IoT server 170. The IoT SuperAgent 140 may encapsulate gateway functionality 145.

Each IoT device 110-118 can treat the supervisor device 130 as a peer and transmit attribute/schema updates to the supervisor device 130. When an IoT device needs to communicate with another IoT device, it can request the pointer to that IoT device from the supervisor device 130 and then communicate with the target IoT device as a peer. The IoT devices 110-118 communicate with each other over a peer-to-peer communication network using a common messaging protocol (CMP). As long as two IoT devices are CMP-enabled and connected over a common communication transport, they can communicate with each other. In the protocol stack, the CMP layer 154 is below the application layer 152 and above the transport layer 156 and the physical layer 158.

In accordance with another aspect of the disclosure, FIG. 1D illustrates a high-level architecture of another wireless communications system 100D that contains a plurality of IoT devices. In general, the wireless communications system 100D shown in FIG. 1D may include various components that are the same and/or substantially similar to the wireless communications systems 100A-100C shown in FIGS. 1A-1C, respectively, which were described in greater detail above. As such, for brevity and ease of description, various details relating to certain components in the wireless communications system 100D shown in FIG. 1D may be omitted herein to the extent that the same or similar details have already been provided above in relation to the wireless communications systems 100A-100C illustrated in FIGS. 1A-1C, respectively.

The Internet 175 is a “resource” that can be regulated using the concept of the IoT. However, the Internet 175 is just one example of a resource that is regulated, and any resource could be regulated using the concept of the IoT. Other resources that can be regulated include, but are not limited to, electricity, gas, storage, security, and the like. An IoT device may be connected to the resource and thereby regulate it, or the resource could be regulated over the Internet 175. FIG. 1D illustrates several resources 180, such as natural gas, gasoline, hot water, and electricity, wherein the resources 180 can be regulated in addition to and/or over the Internet 175.

IoT devices can communicate with each other to regulate their use of a resource 180. For example, IoT devices such as a toaster, a computer, and a hairdryer may communicate with each other over a Bluetooth communication interface to regulate their use of electricity (the resource 180). As another example, IoT devices such as a desktop computer, a telephone, and a tablet computer may communicate over a WiFi communication interface to regulate their access to the Internet 175 (the resource 180). As yet another example, IoT devices such as a stove, a clothes dryer, and a water heater may communicate over a WiFi communication interface to regulate their use of gas. Alternatively, or additionally, each IoT device may be connected to an IoT server, such as IoT server 170, which has logic to regulate their use of the resource 180 based on information received from the IoT devices.

In accordance with another aspect of the disclosure, FIG. 1E illustrates a high-level architecture of another wireless communications system 100E that contains a plurality of IoT devices. In general, the wireless communications system 100E shown in FIG. 1E may include various components that are the same and/or substantially similar to the wireless communications systems 100A-100D shown in FIGS. 1A-1D, respectively, which were described in greater detail above. As such, for brevity and ease of description, various details relating to certain components in the wireless communications system 100E shown in FIG. 1E may be omitted herein to the extent that the same or similar details have already been provided above in relation to the wireless communications systems 100A-100D illustrated in FIGS. 1A-1D, respectively.

The wireless communications system 100E includes two IoT device groups 160A and 160B. Multiple IoT device groups may be connected to and/or communicate with each other via an IoT SuperAgent connected to the Internet 175. At a high level, an IoT SuperAgent may manage inter-group communications among IoT device groups. For example, in FIG. 1E, the IoT device group 160A includes IoT devices 116A, 122A, and 124A and an IoT SuperAgent 140A, while IoT device group 160B includes IoT devices 116B, 122B, and 124B and an IoT SuperAgent 140B. As such, the IoT SuperAgents 140A and 140B may connect to the Internet 175 and communicate with each other over the Internet 175 and/or communicate with each other directly to facilitate communication between the IoT device groups 160A and 160B. Furthermore, although FIG. 1E illustrates two IoT device groups 160A and 160B communicating with each other via IoT SuperAgents 140A and 140B, those skilled in the art will appreciate that any number of IoT device groups may suitably communicate with each other using IoT SuperAgents.

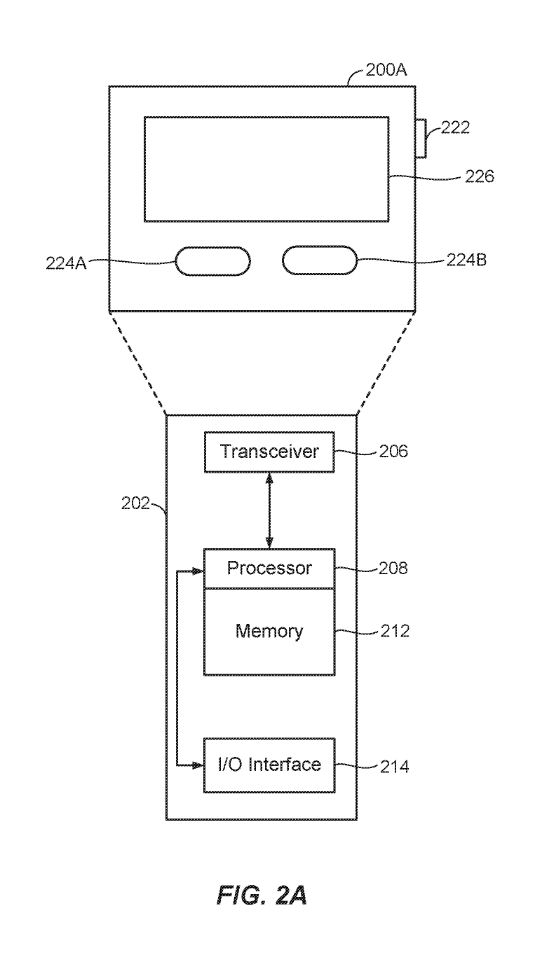

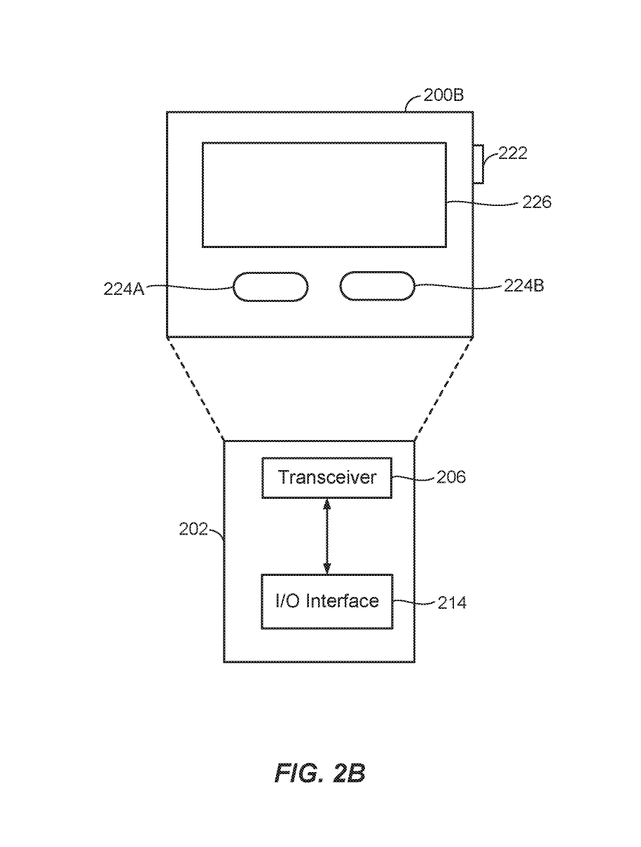

FIG. 2A illustrates a high-level example of an IoT device 200A in accordance with aspects of the disclosure. While external appearances and/or internal components can differ significantly among IoT devices, most IoT devices will have some sort of user interface, which may comprise a display and a means for user input. IoT devices without a user interface can be communicated with remotely over a wired or wireless network, such as air interface 108 in FIGS. 1A-1B.

As shown in FIG. 2A, in an example configuration for the IoT device 200A, an external casing of IoT device 200A may be configured with a display 226, a power button 222, and two control buttons 224A and 224B, among other components, as is known in the art. The display 226 may be a touchscreen display, in which case the control buttons 224A and 224B may not be necessary. While not shown explicitly as part of IoT device 200A, the IoT device 200A may include one or more external antennas and/or one or more integrated antennas that are built into the external casing, including but not limited to WiFi antennas, cellular antennas, satellite position system (SPS) antennas (e.g., global positioning system (GPS) antennas), and so on.

While internal components of IoT devices, such as IoT device 200A, can be embodied with different hardware configurations, a basic high-level configuration for internal hardware components is shown as platform 202 in FIG. 2A. The platform 202 can receive and execute software applications, data and/or commands transmitted over a network interface, such as air interface 108 in FIGS. 1A-1B and/or a wired interface. The platform 202 can also independently execute locally stored applications. The platform 202 can include one or more transceivers 206 configured for wired and/or wireless communication (e.g., a WiFi transceiver, a Bluetooth transceiver, a cellular transceiver, a satellite transceiver, a GPS or SPS receiver, etc.) operably coupled to one or more processors 208, such as a microcontroller, microprocessor, application specific integrated circuit, digital signal processor (DSP), programmable logic circuit, or other data processing device, which will be generally referred to as processor 208. The processor 208 can execute application programming instructions within a memory 212 of the IoT device 200A. The memory 212 can include one or more of read-only memory (ROM), random-access memory (RAM), electrically erasable programmable ROM (EEPROM), flash cards, or any memory common to computer platforms. One or more input/output (I/O) interfaces 214 can be configured to allow the processor 208 to communicate with and control from various I/O devices such as the display 226, power button 222, control buttons 224A and 224B as illustrated, and any other devices, such as sensors, actuators, relays, valves, switches, and the like associated with the IoT device 200A.

Accordingly, an aspect of the disclosure can include an IoT device (e.g., IoT device 200A) including the ability to perform the functions described herein. As will be appreciated by those skilled in the art, the various logic elements can be embodied in discrete elements, software modules executed on a processor (e.g., processor 208) or any combination of software and hardware to achieve the functionality disclosed herein. For example, transceiver 206, processor 208, memory 212, and I/O interface 214 may all be used cooperatively to load, store and execute the various functions disclosed herein and thus the logic to perform these functions may be distributed over various elements. Alternatively, the functionality could be incorporated into one discrete component. Therefore, the features of the IoT device 200A in FIG. 2A are to be considered merely illustrative and the disclosure is not limited to the illustrated features or arrangement.

FIG. 2B illustrates a high-level example of a passive IoT device 200B in accordance with aspects of the disclosure. In general, the passive IoT device 200B shown in FIG. 2B may include various components that are the same and/or substantially similar to the IoT device 200A shown in FIG. 2A, which was described in greater detail above. As such, for brevity and ease of description, various details relating to certain components in the passive IoT device 200B shown in FIG. 2B may be omitted herein to the extent that the same or similar details have already been provided above in relation to the IoT device 200A illustrated in FIG. 2A.

The passive IoT device 200B shown in FIG. 2B may generally differ from the IoT device 200A shown in FIG. 2A in that the passive IoT device 200B may not have a processor, internal memory, or certain other components. Instead, in one embodiment, the passive IoT device 200B may only include an I/O interface 214 or other suitable mechanism that allows the passive IoT device 200B to be observed, monitored, controlled, managed, or otherwise known within a controlled IoT network. For example, in one embodiment, the I/O interface 214 associated with the passive IoT device 200B may include a barcode, Bluetooth interface, radio frequency (RF) interface, RFID tag, IR interface, NFC interface, or any other suitable I/O interface that can provide an identifier and attributes associated with the passive IoT device 200B to another device when queried over a short range interface (e.g., an active IoT device, such as IoT device 200A, that can detect, store, communicate, act on, or otherwise process information relating to the attributes associated with the passive IoT device 200B).

Although the foregoing describes the passive IoT device 200B as having some form of RF, barcode, or other I/O interface 214, the passive IoT device 200B may comprise a device or other physical object that does not have such an I/O interface 214. For example, certain IoT devices may have appropriate scanner or reader mechanisms that can detect shapes, sizes, colors, and/or other observable features associated with the passive IoT device 200B to identify the passive IoT device 200B. In this manner, any suitable physical object may communicate its identity and attributes and be observed, monitored, controlled, or otherwise managed within a controlled IoT network.

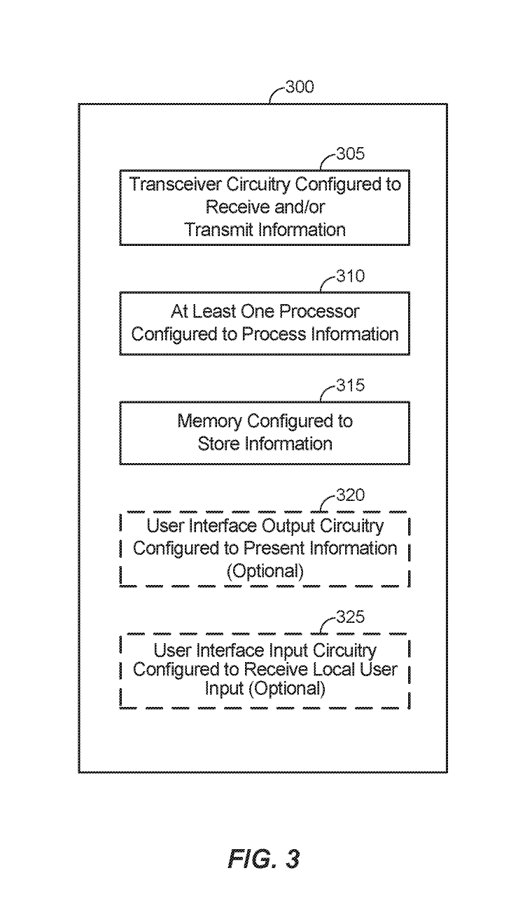

FIG. 3 illustrates a communication device 300 that includes structural components to perform functionality. The communication device 300 can correspond to any of the above-noted communication devices, including but not limited to IoT devices 110-120, IoT device 200A, any components coupled to the Internet 175 (e.g., the IoT server 170), and so on. Thus, communication device 300 can correspond to any electronic device that is configured to communicate with (or facilitate communication with) one or more other entities over the wireless communications systems 100A-100B of FIGS. 1A-1B.

Referring to FIG. 3, the communication device 300 includes transceiver circuitry configured to receive and/or transmit information 305. In an example, if the communication device 300 corresponds to a wireless communications device (e.g., IoT device 200A and/or passive IoT device 200B), the transceiver circuitry configured to receive and/or transmit information 305 can include a wireless communications interface (e.g., Bluetooth, WiFi, WiFi Direct, Long-Term Evolution (LTE) Direct, etc.) such as a wireless transceiver and associated hardware (e.g., an RF antenna, a MODEM, a modulator and/or demodulator, etc.). In another example, the transceiver circuitry configured to receive and/or transmit information 305 can correspond to a wired communications interface (e.g., a serial connection, a USB or Firewire connection, an Ethernet connection through which the Internet 175 can be accessed, etc.). Thus, if the communication device 300 corresponds to some type of network-based server (e.g., the IoT server 170), the transceiver circuitry configured to receive and/or transmit information 305 can correspond to an Ethernet card, in an example, that connects the network-based server to other communication entities via an Ethernet protocol. In a further example, the transceiver circuitry configured to receive and/or transmit information 305 can include sensory or measurement hardware by which the communication device 300 can monitor its local environment (e.g., an accelerometer, a temperature sensor, a light sensor, an antenna for monitoring local RF signals, etc.). The transceiver circuitry configured to receive and/or transmit information 305 can also include software that, when executed, permits the associated hardware of the transceiver circuitry configured to receive and/or transmit information 305 to perform its reception and/or transmission function(s). However, the transceiver circuitry configured to receive and/or transmit information 305 does not correspond to software alone, and the transceiver circuitry configured to receive and/or transmit information 305 relies at least in part upon structural hardware to achieve its functionality.

Referring to FIG. 3, the communication device 300 further includes at least one processor configured to process information 310. Example implementations of the type of processing that can be performed by the at least one processor configured to process information 310 includes but is not limited to performing determinations, establishing connections, making selections between different information options, performing evaluations related to data, interacting with sensors coupled to the communication device 300 to perform measurement operations, converting information from one format to another (e.g., between different protocols such as .wmv to .avi, etc.), and so on. For example, the at least one processor configured to process information 310 can include a general purpose processor, a DSP, an ASIC, a field programmable gate array (FPGA) or other programmable logic device, discrete gate or transistor logic, discrete hardware components, or any combination thereof designed to perform the functions described herein. A general purpose processor may be a microprocessor, but in the alternative, the at least one processor configured to process information 310 may be any conventional processor, controller, microcontroller, or state machine. A processor may also be implemented as a combination of computing devices (e.g., a combination of a DSP and a microprocessor, a plurality of microprocessors, one or more microprocessors in conjunction with a DSP core, or any other such configuration). The at least one processor configured to process information 310 can also include software that, when executed, permits the associated hardware of the at least one processor configured to process information 310 to perform its processing function(s). However, the at least one processor configured to process information 310 does not correspond to software alone, and the at least one processor configured to process information 310 relies at least in part upon structural hardware to achieve its functionality.

Referring to FIG. 3, the communication device 300 further includes memory configured to store information 315. In an example, the memory configured to store information 315 can include at least a non-transitory memory and associated hardware (e.g., a memory controller, etc.). For example, the non-transitory memory included in the memory configured to store information 315 can correspond to RAM, flash memory, ROM, erasable programmable ROM (EPROM), EEPROM, registers, hard disk, a removable disk, a CD-ROM, or any other form of storage medium known in the art. The memory configured to store information 315 can also include software that, when executed, permits the associated hardware of the memory configured to store information 315 to perform its storage function(s). However, the memory configured to store information 315 does not correspond to software alone, and the memory configured to store information 315 relies at least in part upon structural hardware to achieve its functionality.

Referring to FIG. 3, the communication device 300 further optionally includes user interface output circuitry configured to present information 320. In an example, the user interface output circuitry configured to present information 320 can include at least an output device and associated hardware. For example, the output device can include a video output device (e.g., a display screen, a port that can carry video information such as USB, HDMI, etc.), an audio output device (e.g., speakers, a port that can carry audio information such as a microphone jack, USB, HDMI, etc.), a vibration device and/or any other device by which information can be formatted for output or actually outputted by a user or operator of the communication device 300. For example, if the communication device 300 corresponds to the IoT device 200A as shown in FIG. 2A and/or the passive IoT device 200B as shown in FIG. 2B, the user interface output circuitry configured to present information 320 can include the display 226. In a further example, the user interface output circuitry configured to present information 320 can be omitted for certain communication devices, such as network communication devices that do not have a local user (e.g., network switches or routers, remote servers, etc.). The user interface output circuitry configured to present information 320 can also include software that, when executed, permits the associated hardware of the user interface output circuitry configured to present information 320 to perform its presentation function(s). However, the user interface output circuitry configured to present information 320 does not correspond to software alone, and the user interface output circuitry configured to present information 320 relies at least in part upon structural hardware to achieve its functionality.

Referring to FIG. 3, the communication device 300 further optionally includes user interface input circuitry configured to receive local user input 325. In an example, the user interface input circuitry configured to receive local user input 325 can include at least a user input device and associated hardware. For example, the user input device can include buttons, a touchscreen display, a keyboard, a camera, an audio input device (e.g., a microphone or a port that can carry audio information such as a microphone jack, etc.), and/or any other device by which information can be received from a user or operator of the communication device 300. For example, if the communication device 300 corresponds to the IoT device 200A as shown in FIG. 2A and/or the passive IoT device 200B as shown in FIG. 2B, the user interface input circuitry configured to receive local user input 325 can include the buttons 222, 224A, and 224B, the display 226 (if a touchscreen), etc. In a further example, the user interface input circuitry configured to receive local user input 325 can be omitted for certain communication devices, such as network communication devices that do not have a local user (e.g., network switches or routers, remote servers, etc.). The user interface input circuitry configured to receive local user input 325 can also include software that, when executed, permits the associated hardware of the user interface input circuitry configured to receive local user input 325 to perform its input reception function(s). However, the user interface input circuitry configured to receive local user input 325 does not correspond to software alone, and the user interface input circuitry configured to receive local user input 325 relies at least in part upon structural hardware to achieve its functionality.

Referring to FIG. 3, while the configured structural components of 305 through 325 are shown as separate or distinct blocks in FIG. 3 that are implicitly coupled to each other via an associated communication bus (not shown expressly), it will be appreciated that the hardware and/or software by which the respective configured structural components of 305 through 325 performs their respective functionality can overlap in part. For example, any software used to facilitate the functionality of the configured structural components of 305 through 325 can be stored in the non-transitory memory associated with the memory configured to store information 315, such that the configured structural components of 305 through 325 each performs their respective functionality (i.e., in this case, software execution) based in part upon the operation of software stored by the memory configured to store information 315. Likewise, hardware that is directly associated with one of the configured structural components of 305 through 325 can be borrowed or used by other configured structural components of 305 through 325 from time to time. For example, the at least one processor configured to process information 310 can format data into an appropriate format before being transmitted by the transceiver circuitry configured to receive and/or transmit information 305, such that the transceiver circuitry configured to receive and/or transmit information 305 performs its functionality (i.e., in this case, transmission of data) based in part upon the operation of structural hardware associated with the at least one processor configured to process information 310.

Accordingly, the various structural components of 305 through 325 are intended to invoke an aspect that is at least partially implemented with structural hardware, and are not intended to map to software-only implementations that are independent of hardware and/or to non-structural functional interpretations. Other interactions or cooperation between the structural components of 305 through 325 in the various blocks will become clear to one of ordinary skill in the art from a review of the aspects described below in more detail.

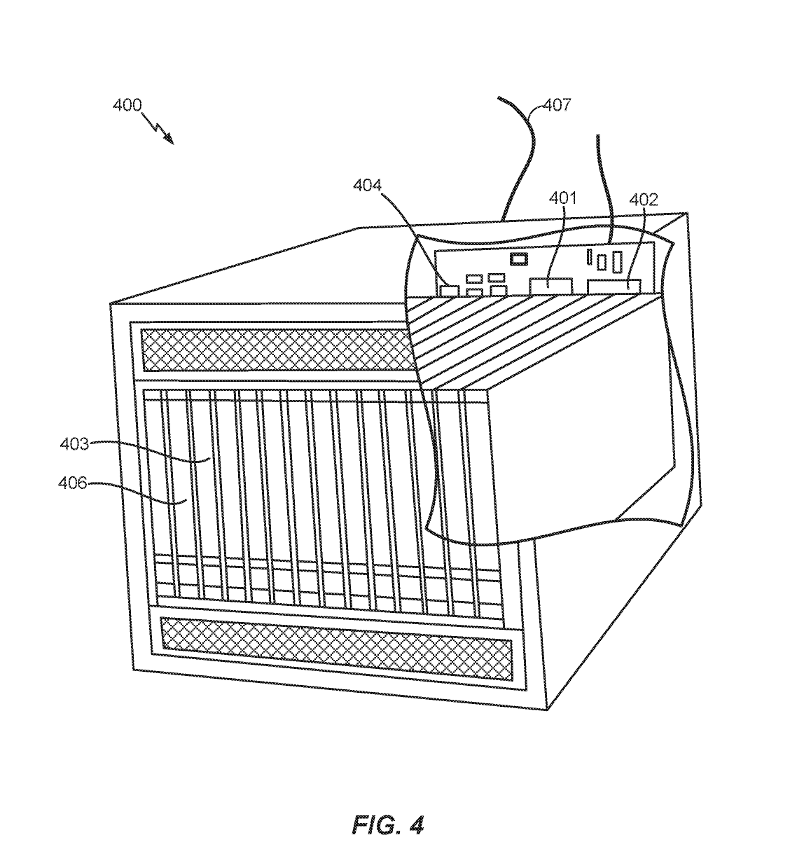

The various embodiments may be implemented on any of a variety of commercially available server devices, such as server 400 illustrated in FIG. 4. In an example, the server 400 may correspond to one example configuration of the IoT server 170 described above. In FIG. 4, the server 400 includes a processor 401 coupled to volatile memory 402 and a large capacity nonvolatile memory, such as a disk drive 403. The server 400 may also include a floppy disc drive, compact disc (CD) or DVD disc drive 406 coupled to the processor 401. The server 400 may also include network access ports 404 coupled to the processor 401 for establishing data connections with a network 407, such as a local area network coupled to other broadcast system computers and servers or to the Internet. In context with FIG. 3, it will be appreciated that the server 400 of FIG. 4 illustrates one example implementation of the communication device 300, whereby the transceiver circuitry configured to transmit and/or receive information 305 corresponds to the network access ports 404 used by the server 400 to communicate with the network 407, the at least one processor configured to process information 310 corresponds to the processor 401, and the memory configured to store information 315 corresponds to any combination of the volatile memory 402, the disk drive 403 and/or the disc drive 406. The optional user interface output circuitry configured to present information 320 and the optional user interface input circuitry configured to receive local user input 325 are not shown explicitly in FIG. 4 and may or may not be included therein. Thus, FIG. 4 helps to demonstrate that the communication device 300 may be implemented as a server, in addition to an IoT device implementation as in FIG. 2A.

Mobile devices (e.g., cellular phones, tablet computers, laptop computers, etc.) can be used to control proximate devices, such as Internet of Things (IoT) devices over an IoT network. For example, in an IoT-specific example, mobile devices can adjust light output by one or more proximate IoT light bulbs, speaker output by one or more proximate IoT speakers (or an IoT receiver controlling one or more speakers coupled thereto), and so on. Generally, to control proximate devices, a mobile device is required to enter into a high-power mode of operation. For example, if the mobile device is in a low power mode (e.g., sleep mode, etc.), a user may be required to unlock the mobile device in order to enter a high power mode or active mode, navigate to a control application that is configured to control the proximate devices, launch the control application, authenticate him/herself with the control application as having sufficient privileges for controlling the proximate devices, and only at this point is the user in a position to manipulate the control application in order to implement any desired changes with respect to operation of the proximate devices. Accordingly, there are typically multiple steps that the user must make with respect to the mobile device before being able to control the proximate devices.

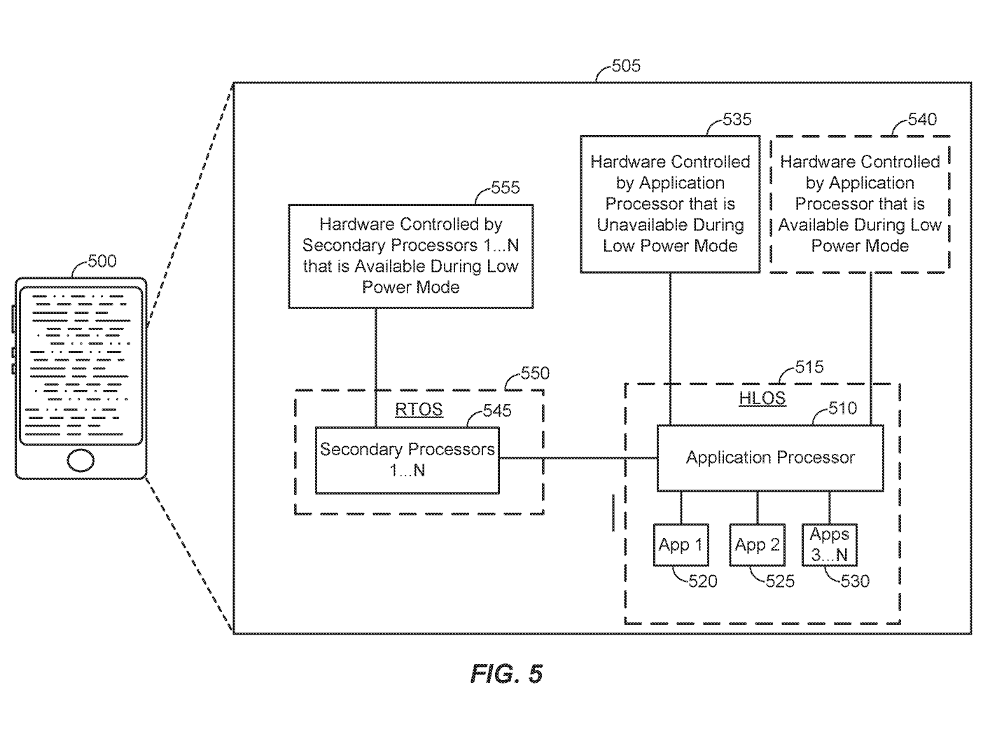

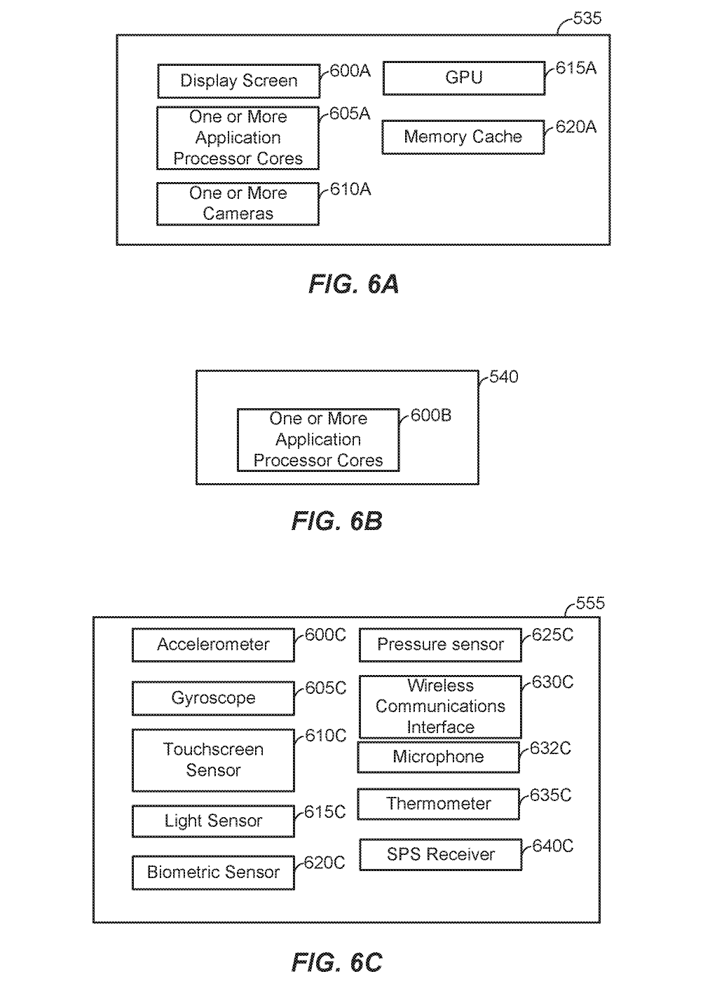

FIG. 5 illustrates a mobile device 500 that is provisioned with a multi-processor platform 505 that includes an application processor 510 and secondary processors 1 . . . N, 545, whereby N is greater than or equal to 1 in accordance with an embodiment of the disclosure. As will be described in more detail below, the mobile device 500 can be configured to control one or more proximate devices, such as IoT devices over an IoT network as described above with respect to FIGS. 1A-1E. The application processor 510 is configured to execute a High Level Operating Systems (HLOS) 515 (e.g., Android, iOS, Windows Mobile, etc.). A number of applications 1 . . . N, 520-530, are configured to be executed by the application processor 510 within the HLOS 515. Moreover, certain hardware provisioned on the mobile device 500 is generally controlled by the application processor 510. This hardware can be categorized as hardware that is configured to be controlled by the application processor 510 in an “active mode” only while being unavailable during a “low power mode”, 535, and (optionally) hardware that is configured to be controlled by the application processor 510 in either active mode or low power mode. Examples of the hardware 535 that is unavailable during the low power mode and the hardware 540 that is optionally available during both the low power mode and active mode are described below with respect to FIGS. 6A and 6B, respectively.

Referring to FIG. 5, the secondary processors 1 . . . N 545 are configured to execute a Real-Time Operating System (RTOS), 550. Generally, the RTOS 550 controls hardware 555 that remains available during low power mode. Generally, the RTOS 550 controls features which are delay-sensitive and/or have low-latency requirements, such as physical sensors, wireless communications, and so on. Examples of the hardware 555 that is controlled by the secondary processors 1 . . . N 545 and is available during the low power mode are described below with respect to FIG. 6C. The secondary processors 1 . . . N 545 may include one or more Digital Signal Processors (DSPs) that are configured to interact with a set of sensors (e.g., see FIG. 6C), and/or one or more baseband processors that are configured to control one or more wireless communication interfaces (e.g., Bluetooth, Near Field Communication (NFC), WiFi, cellular, etc.).

FIG. 6A illustrates the hardware 535 of FIG. 5 that is unavailable during the low power mode in accordance with an embodiment of the disclosure. Referring to FIG. 6A, the hardware 535 includes a display screen 600A, one or more application processor cores 605A of the application processor 510, one or more cameras 610A, a graphical processing unit (GPU) 615A and a memory cache 620A. The one or more application processor cores 605A being unavailable during the low power mode implies that the application processor 510 can be considered partially or fully asleep (e.g., in the power collapse state or dormant state) during the low power mode, although it is possible that some cores remain active to permit execution of certain low-intensive tasks during the low power mode. The one or more cameras 610A can include a front-facing camera, a rear-facing camera, or both. Accordingly, during the low power mode, the display screen 600A will generally be shut off while the mobile device 500 is in a “locked” state with some or all of the application processor cores 605A being in the power collapse state or dormant state, and the GPU 615A and the one or more cameras 610A being inactive, and while one or more of applications 1 . . . N 520-530 are scheduled to run at fixed times by the application processor 510 to reduce power drain.

As will be appreciated, different levels of power consumption mitigation can fall under the general classification of low power mode. For example, some low power modes may permit the front-facing camera to remain active while only disabling the rear-facing camera, whereas other low power modes may require all cameras 610A to be inactive. In another example, some low power modes may require that all application processor cores 605A of the application processor 510 be in the power collapse state or dormant state while other low power modes permit a threshold number of application processor cores 605A to remain active. However, there are certain intrinsic characteristics that are common to any low power mode implementation as used herein. In particular, as used herein, the low power mode requires hardware associated with the application processor 510 to undergo power collapse (no power) or be dormant (very little power consumption). In particular, the hardware that is maintained in a power collapse state or a dormant state includes at least one core of the application processor 510, and potentially other hardware as well, including but not limited to the memory cache 620A, the GPU 615A and/or any other type of sub-system that allows for power management from the application processor 510, whereby power management includes the capability of taking direction in terms of when the associated hardware is required to be turned on or turned off. Moreover, some but not necessarily all low power mode implementations will also further place hardware (e.g., the camera(s) 610A, the GPU 615A, etc.) that is non-crucial to the functions of detecting user actions and facilitating device action implementation as described below into an idle or standby mode that draws less power relative to being kept in an active mode.

FIG. 6B illustrates the hardware 540 of FIG. 5 that is optionally available during the low power mode in accordance with an embodiment of the disclosure. Referring to FIG. 6B, the hardware 540 includes one or more application processor cores 600B of the application processor 510. As will be appreciated, the one or more application processor cores 600B are necessarily different than the one or more application processor cores 605A from FIG. 6A. When the one or more application processor cores 600B remain available during the low power mode, the one or more application processor cores 600B correspond to less than all of the processor cores in the application processor 510. The one or more application processor cores 600B, if retained in an active or non-dormant state during the low power mode, can permit execution of certain low-intensive tasks during the low power mode.

FIG. 6C illustrates the hardware 555 of FIG. 5 that is available during the low power mode under the control of the secondary processors 1 . . . N 545 in accordance with an embodiment of the disclosure. Referring to FIG. 6C, the hardware 555 includes sensors such as an accelerometer 600C, a gyroscope 605C, a touchscreen sensor 610C that tracks user finger movements in proximity to the display screen 600A, a light sensor 615C that monitors ambient light conditions, at least one biometric sensor 620C (e.g., a fingerprint scanner, a retinal scanner, etc.), and a pressure sensor 625C (e.g., to detect how hard the mobile device 500 is being squeezed, etc.). The hardware 555 further includes at least one wireless communications interface 630C, which can include hardware for facilitating wireless communications over various wireless communication protocols such as Bluetooth, NFC, WiFi and/or cellular. The hardware 555 further includes a microphone 632C (e.g., to receive voice commands from the user, to monitor ambient noise or detect particular audio control signals or beacons, etc.), a thermometer 635C (e.g., to monitor ambient temperature, etc.) and a satellite positioning system (SPS) receiver 640C (e.g., a GPS receiver) that is configured to monitor satellite signals that can be used to track a location of the mobile device 500.

As will be appreciated, FIGS. 6A-6C illustrate non-limiting examples of the hardware that can be populated within 535, 540 and 555, respectively, in FIG. 5. The specific non-limiting hardware examples in FIGS. 6A-6C can be used in any combination, and additional hardware that is not expressly illustrated in FIGS. 6A-6C can also be included among the hardware 535, 540 and 555, respectively, in FIG. 5 to accommodate different low power mode implementations.

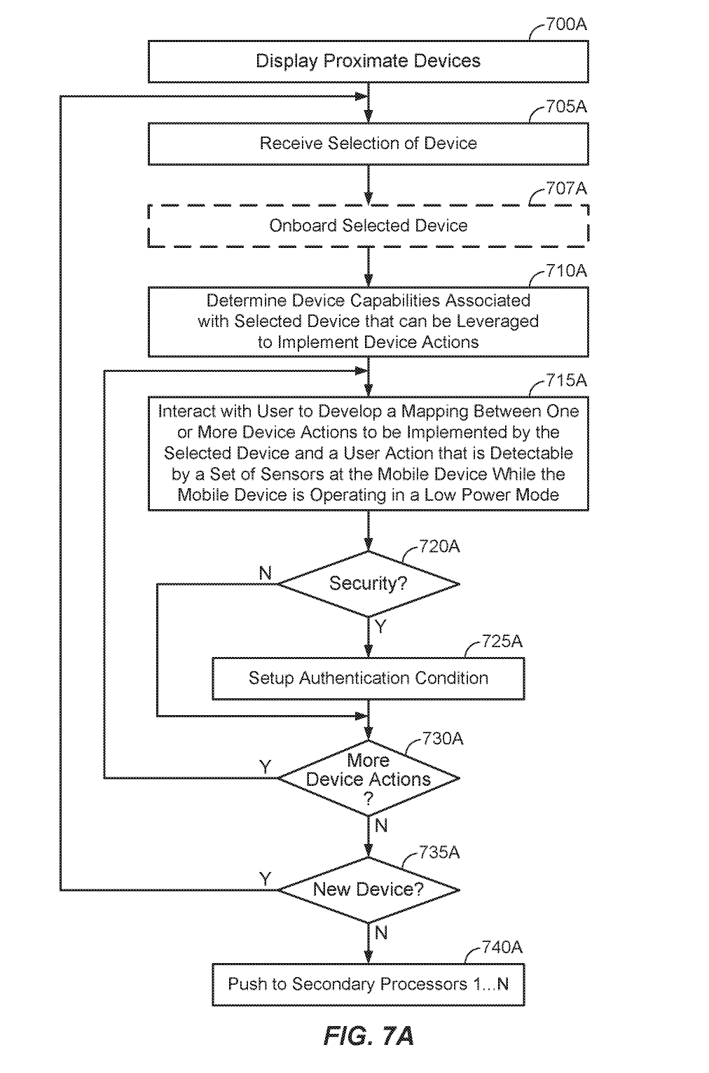

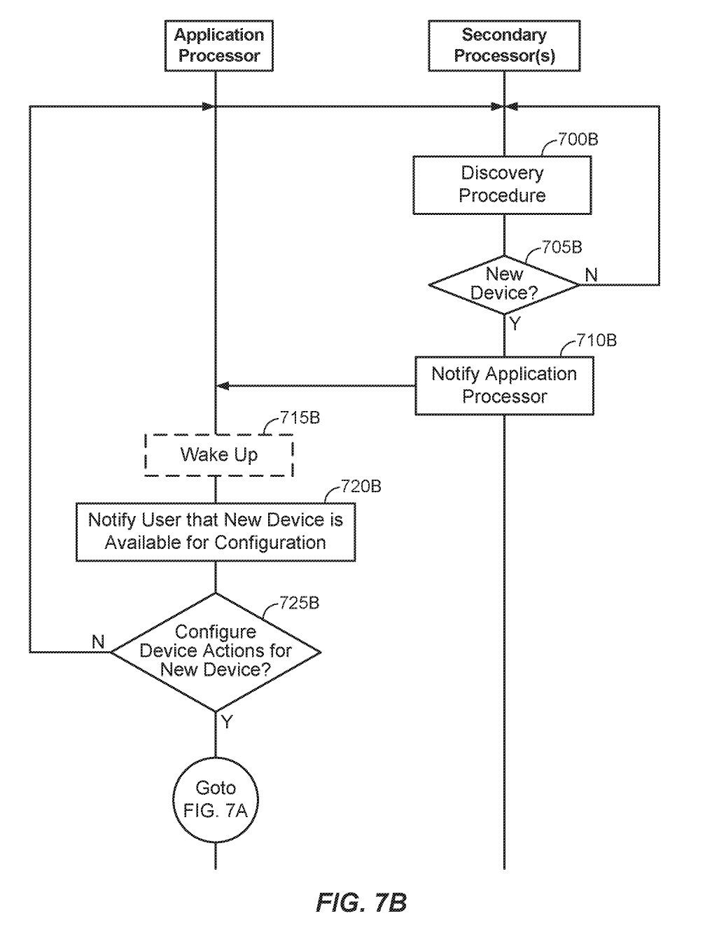

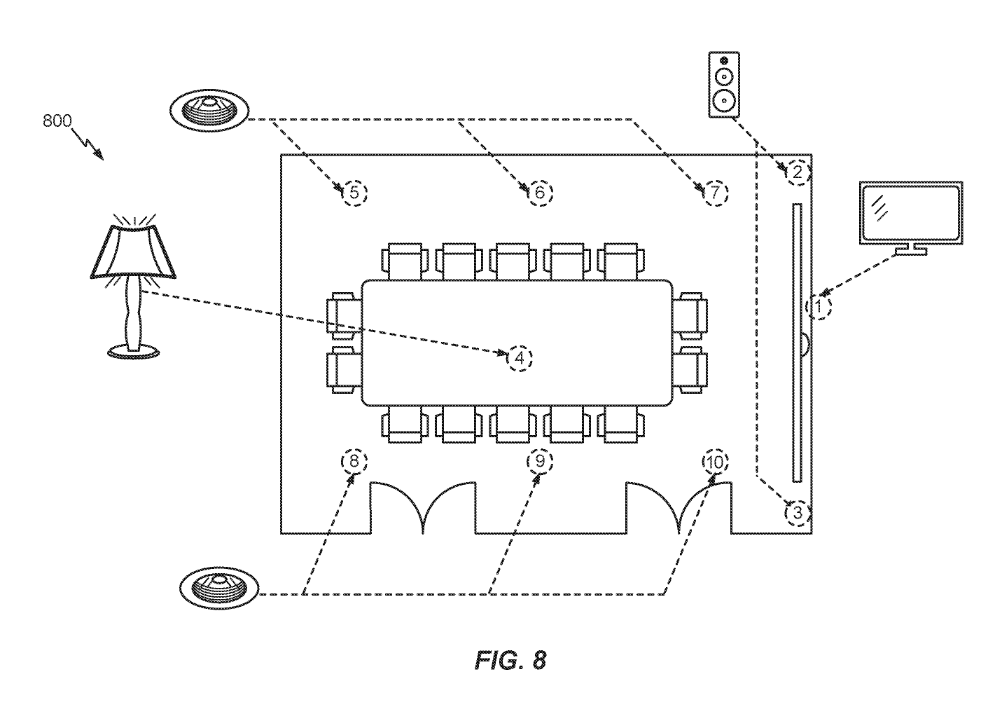

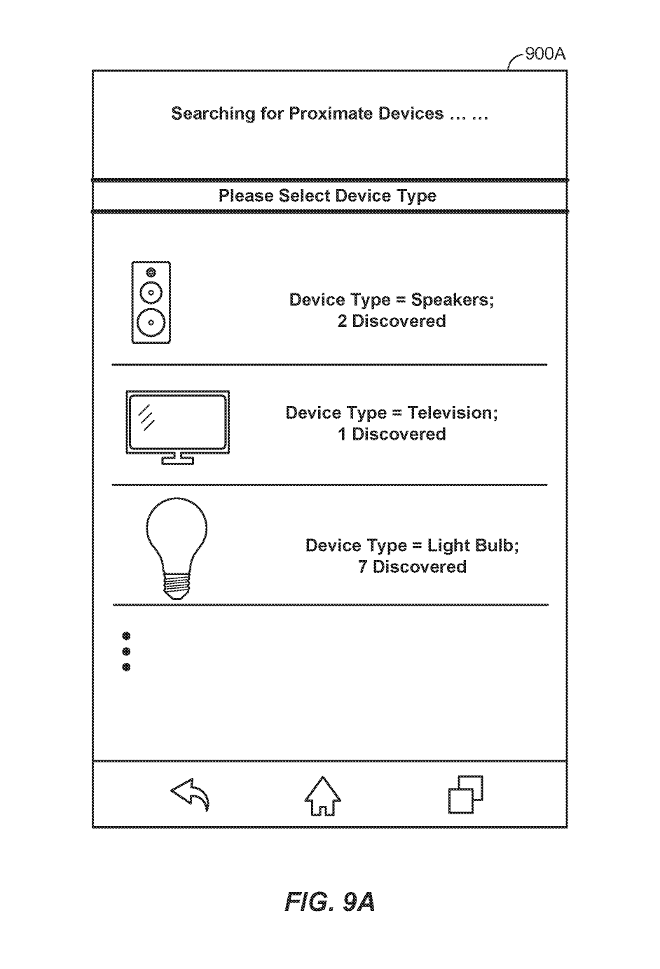

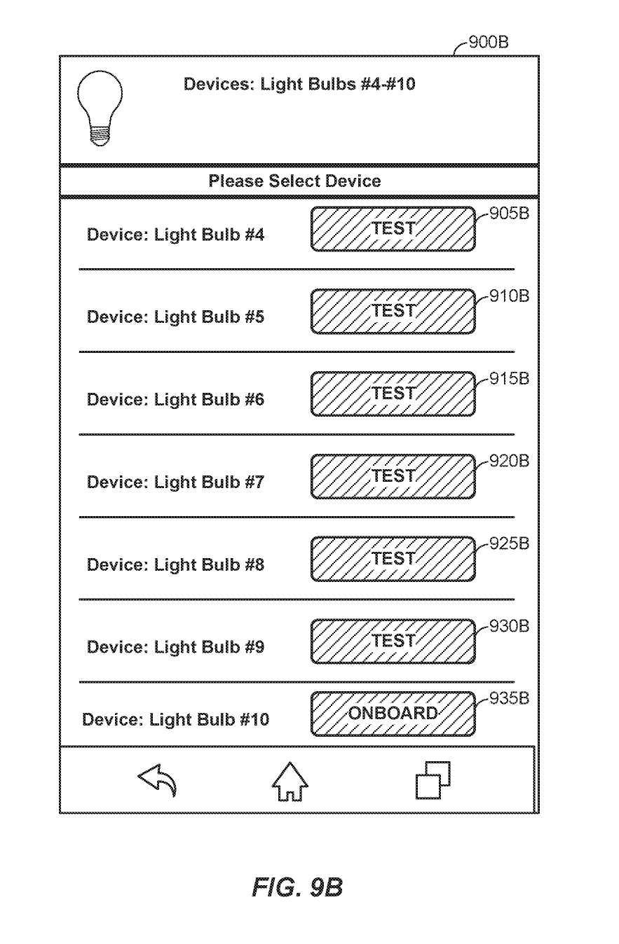

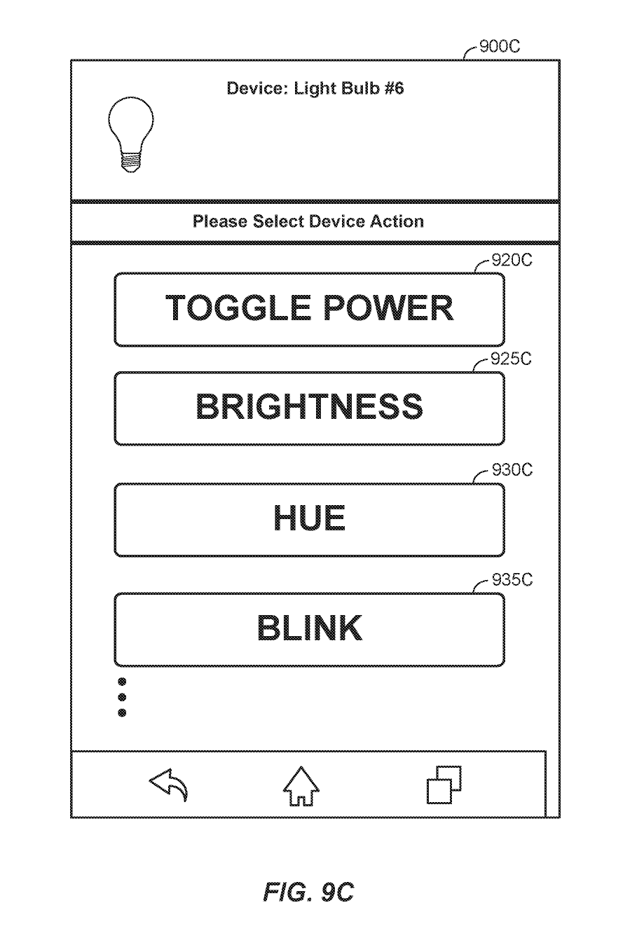

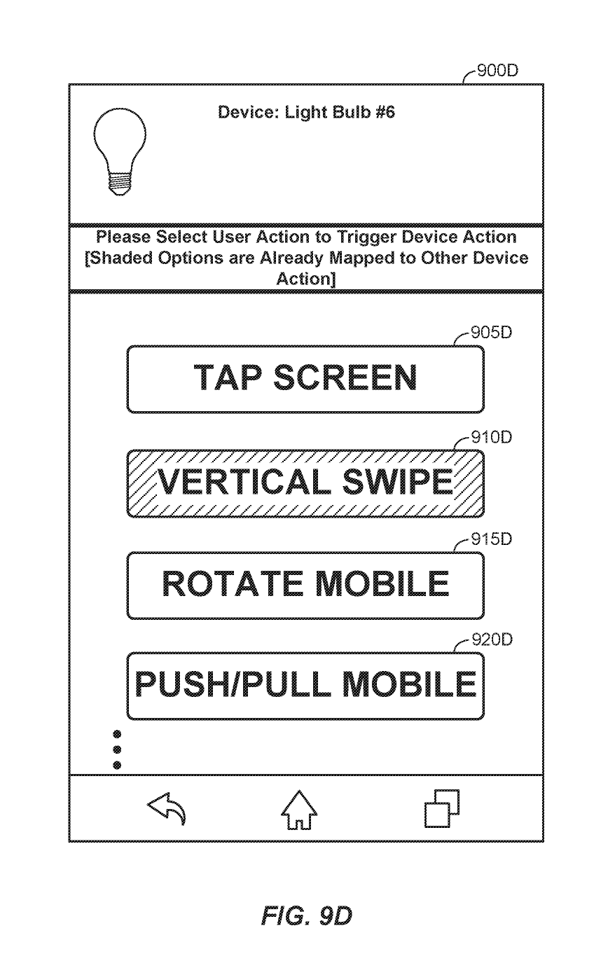

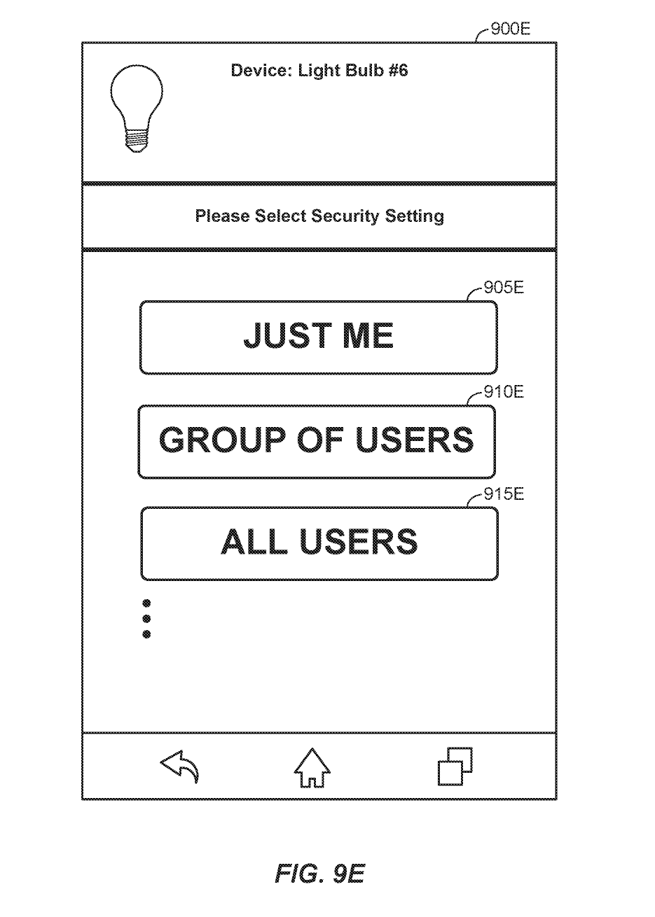

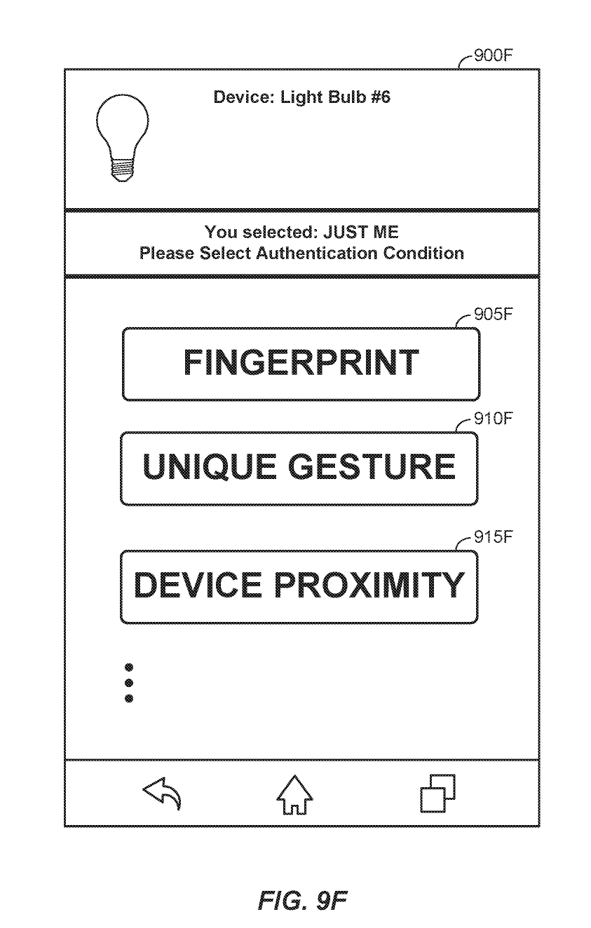

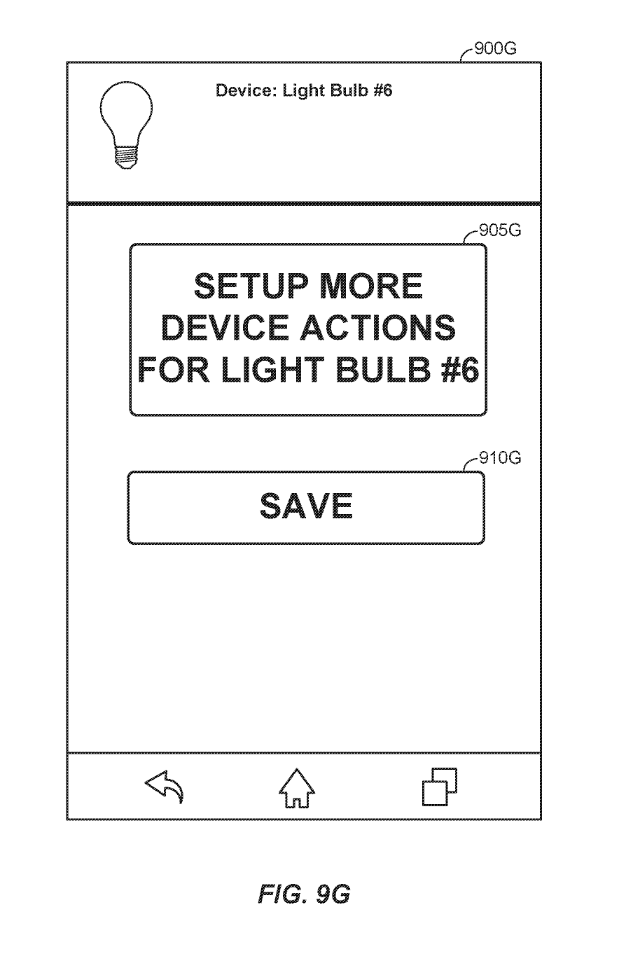

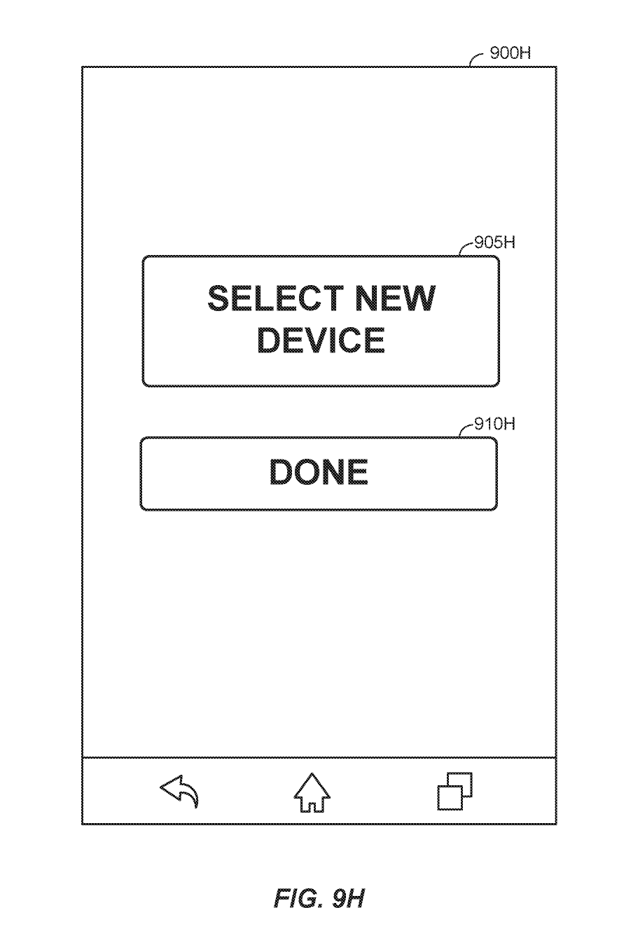

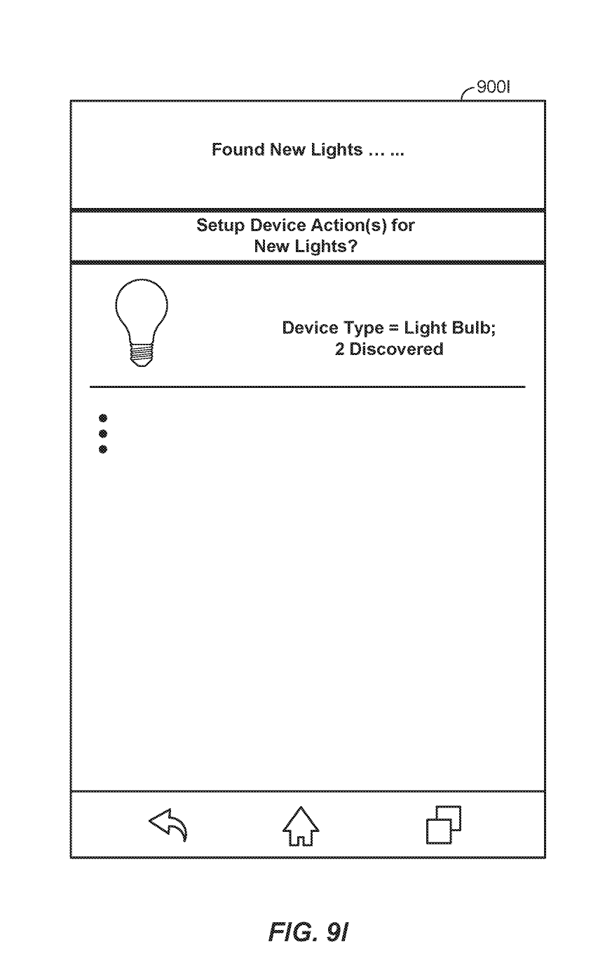

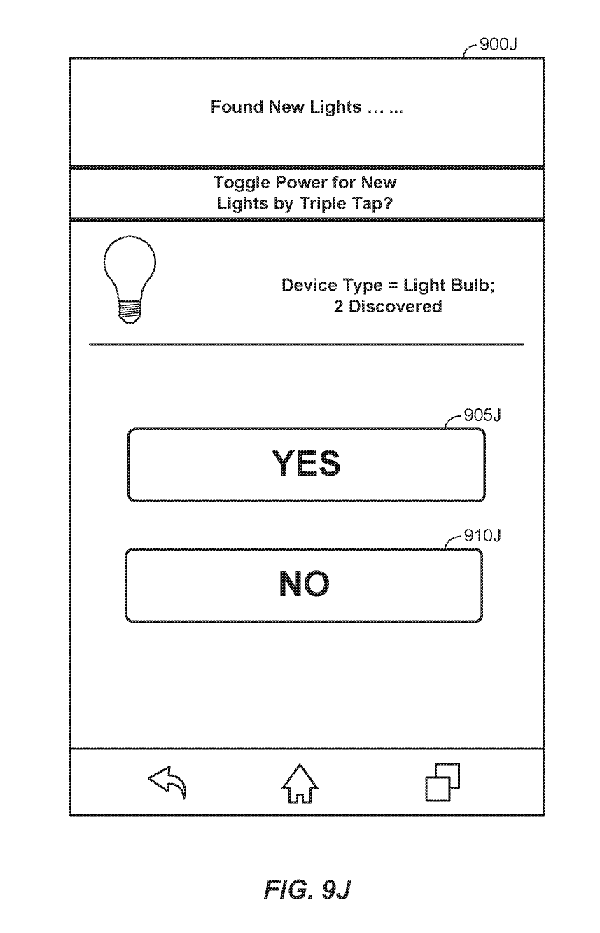

FIG. 7A illustrates a configuration procedure by which user actions (or triggers) that are detectable at the mobile device 500 are mapped to device actions to be implemented at one or more proximate devices relative to the mobile device 500 in accordance with an embodiment of the disclosure. In an example, the operations depicted in FIG. 7A are executed by the application processor 510 (or more specifically, a configuration or control application that is executed by the application processor 510) while the mobile device 500 is operating in active mode. FIG. 7B illustrates an example of a discovery procedure performed by the secondary processors 1 . . . N 545 that can trigger execution of the process of FIG. 7A in accordance with an embodiment of the disclosure. Below, the process of FIG. 7A is described with respect to FIGS. 8-9H, and the process of FIG. 7B is described with respect to FIGS. 9I-9J.

Referring to FIG. 7A, the application processor 510 displays a list of proximate devices via the display screen 600A, 700A. The list of proximate devices that is displayed at 700A can be detected in response to manual action by the user (e.g., the user launches a configuration application on the mobile device 500 that requests initiation of a local device search) or based on an automated or background detection of a new device (e.g., discussed below in more detail with respect to FIGS. 7B and 9I-9J). Generally, devices are deemed proximate if the respective devices are within communication range of a local wireless communications interface (e.g., Bluetooth, NFC, WiFi, etc.), which can correspond to an IoT communications interface in an IoT implementation.

In a further example, the list of proximate devices that is displayed at 700A can include one or more devices that are part of (i.e., have already been “onboarded to”) a local wireless network (e.g., an IoT network, a WLAN, etc.) to which the mobile device 500 is already onboarded. For onboarded devices, the local wireless communications interface will generally correspond to the wireless interface used by the local wireless network (e.g., an IoT interface for an IoT network, etc.), although a separate direct wireless interface could also be used (e.g., a WiFi-Direct, Bluetooth or LTE-D connection via P2P that is not used by an IoT network to which the devices have been onboarded). The list of proximate devices that is displayed at 700A can also include one or more devices that are not part of (i.e., have not yet been “onboarded to”) the local wireless network. The manner in which devices (onboarded or non-onboarded) can be discovered for subsequent display at 700A is described in more detail below with respect to FIG. 7B. In a further example, it is possible that the list of proximate devices includes only onboarded devices of only non-onboarded devices. If the list of proximate devices includes only non-onboarded devices, the mobile device 500 may opt to interact with these proximate devices via direct P2P communication of the local wireless communications interface without the proximate devices being onboarded to the local wireless network.

With reference to FIG. 8, a conference room 800 is depicted which includes ten (10) devices (e.g., IoT devices) that are configured to be controlled, at least in part, by the mobile device 500 over the local wireless communications interface. In particular, the conference room 800 includes a television #1, front-left speaker #2, front-right speaker #3, a desk lamp equipped with a light bulb #4, and six recessed lights equipped with light bulbs #5 . . . #10, respectively. Accordingly, assuming that the mobile device 500 is in the conference room 800 depicted in FIG. 8, the list of proximate devices can be displayed at 700A as shown in screen 900A of FIG. 9A. In particular, screen 900A shows the detected proximate devices organized by device type (e.g., television, speaker and light bulb) along with a number of devices in each device type being indicated (e.g., 1 television, 2 speakers, 7 light bulbs).

Referring to FIG. 7A, the application processor 510 receives a selection of one of the displayed proximate devices, 705A. For example, assume that the user of the mobile device 500 selects the light bulb device type in response to the screen 900A of FIG. 9A, which results in screen 900B of FIG. 9B being presented to the user. In FIG. 9B, an example is shown whereby light bulbs #4 . . . #9 are already onboarded to the local wireless network, while light bulb #10 has not yet been onboarded. In screen 900B, light bulbs #4 . . . #9 are displayed in association with respective TEST buttons 905B . . . 930B, while light bulb #10 is displayed in association with an ONBOARD button 935B. The TEST buttons 905B . . . 930B are configured to trigger a communication to the associated device for triggering a user-viewable signal (e.g., if TEST button 905B is selected, light bulb #4 may blink or turn on and off quickly or provide some other signal so that the user can figure out which light bulb is which in the conference room 800). The ONBOARD button 935B by contrast is configured to trigger onboarding of light bulb #10 to the local wireless network. If selected, the ONBOARD button 935B will cause light bulb #10 to be onboarded to the local wireless network, after which the ONBOARD button 935B can be replaced with a TEST button, similar to TEST buttons 905B . . . 930B. Accordingly, in this example, onboarding is required to implement to trigger a test operation at the respective device, although in other implementations a non-onboarded device could be tested (e.g., onboarding is not necessarily a precondition to testing a device in other embodiments). In this example, the user can input a device selection via the screen 900B which corresponds to the device selection received at 705A.

Referring to FIG. 7A, at 707A, after the device is selected at 705A, the mobile device 500 facilitates onboarding of the selected device to the local wireless network (e.g., an IoT network), if necessary. In the example of FIG. 9B, the onboarding operation of 707A can be triggered via selection of the ONBOARD button 935B in screen 900B of FIG. 9B. The onboarding operation of 707A is optional and can be skipped if the selected device is already onboarded onto the local wireless network. Further, if onboarding is otherwise not desired, such as if the mobile device 500 intends to control the selected device via another mechanism (e.g., P2P that is independent of the local wireless network), the onboarding operation of 707A can also be skipped. The onboarding operation of 707A can occur in a variety of ways. For example, the mobile device 500 can provide the selected device with information related to the local wireless network to prompt the selected device to contact the local wireless network for onboarding, the mobile device 500 can provide the local wireless network with information related to the selected device to prompt the local wireless network to contact the selected device for onboarding, etc.

Referring to FIG. 7A, at 710A, the application processor 510 determines one or more device capabilities associated with the selected device that can be leveraged to implement device actions. The device capability discovery of 710A can be performed in a variety of ways. For example, during a discovery phase, a unique device identifier can be obtained that identifies the selected device, or a device-type identifier can be used to identify a class of the selected device. This information is then used to look up the device capabilities of the selected device. In another example, during or after the discovery phase, the selected device can send a signal (e.g., a periodic device capabilities overhead or broadcast signal, a signal sent in response to a device capabilities query from the mobile device 500 after the device selection of 705A, etc.) that expressly indicates its associated device capabilities. At 715A, the application processor 510 interacts with the user to develop a mapping between one or more device actions to be implemented by the selected device and a user action that is detectable by a set of sensors (e.g., one or more of sensors 600C . . . 625C of FIG. 6C) at the mobile device 500 while the mobile device 500 is operating in the low power mode.

An example implementation of 705A-715A of FIG. 7A will now be described with respect to FIGS. 9C and 9D. Assume that light bulb #6 from screen 900B of FIG. 9B is selected by the user (e.g., as in 705A of FIG. 7A), which results in screen 900C of FIG. 9C being displayed to the user. Screen 900C prompts the user to select between available device actions that can be implemented at light bulb #6 based on the associated device capabilities of light bulb #6 (e.g., determined as in 710A of FIG. 7A); namely, toggle power 920C (e.g., turn light bulb #6 on or off), brightness 925C (e.g., adjust a brightness level of light bulb #6), hue 930C (e.g., adjust a hue or color-tone of light bulb #6) and blink 935C (e.g., initiate a blinking feature at a designated frequency or intensity). The user can select one of the available device actions 920C-935C, and while not shown, the user can further configure the device actions (e.g., by establishing a default brightness level or hue at which the light bulb #6 is to be configured when turned on in accordance with the toggle power 920C device action, a particular target brightness level or a particular target brightness level change for brightness 925C, and so forth). Screen 900D of FIG. 9D prompts the user to select between available sensor-detectable user actions to be used as a trigger for the above-noted action. In particular, the user actions in screen 900D include TAP SCREEN 905D (e.g., the user can tap the display screen 600A N times or at a particular location to trigger the device action), VERTICAL SWIPE 910D (e.g., the user can swipe his/her finger across the display screen 600A vertically to trigger the device action), ROTATE MOBILE 915D (e.g., the user can rotate the orientation of the mobile device 500 to trigger the device action) or PUSH/PULL MOBILE 920D (e.g., the user can push or pull the mobile device 500 to trigger the device action). In screen 900D, the VERTICAL SWIPE 910D is shaded too indicate that at least one other device action is already associated with this particular user action. When a user action is already associated with an existing device action, the user action can still be available for selection, in which case multiple device actions are mapped to the same user action. Alternatively, it is possible that the user wants only one device action mapped to each user action, in which case VERTICAL SWIPE 910D would be non-selectable or a selection of VERTICAL SWIPE 910D would function to de-map the VERTICAL SWIPE 910D from its previous mapped device action.

Referring to FIG. 7A, the user is prompted to select whether to secure the device action trigger that is established at 715A, 720A. For example, the user may be a parent or other administrative user that does not want to give anyone who mimics the user action the power to trigger the associated device action. In an example, the user can be prompted with screen 900E of FIG. 9E, whereby the user selects between JUST ME 905E (e.g., the user is the only person with authority to trigger the device action via its associated user action established at 715A), GROUP OF USERS 910E (e.g., the user will select a particular group of users with authority to trigger the device action via its associated user action established at 715A) or ALL USERS 915E (e.g., all users have the authority to trigger the device action via its associated user action established at 715A). As will be appreciated, JUST ME 905E and GROUP OF USERS 910E require some type of security, while ALL USERS 915E does not require security. Referring to FIG. 7A, if the user determines to secure the device action trigger at 720A, an authentication condition for the device action trigger is established at 725A. For example, the user can be prompted with screen 900F of FIG. 9F, where the user can select between a variety of authentication conditions such as FINGERPRINT 905F (e.g., a fingerprint of an authorized user is required to permit the device action based on its associated user action) UNIQUE GESTURE 910F (e.g., a unique gesture that is not expected to be easily faked is required to be performed before the device action is permitted to be triggered by its associated user action), DEVICE PROXIMITY 915F (e.g., the presence of a designated device such as a smart watch, a smart key or keychain or other device that the user is generally expected to keep in their possession is required to be verified as being in proximity before the device action is permitted to be triggered by its associated user action) or any combination thereof (e.g., the user can select options 905F, 910F and 915F in any combination, so that, in an example, both the user's fingerprint and proximate smart-watch must be detected so as to authenticate the user before the device action is permitted to be triggered by its associated user action). If the user determines not to secure the device action trigger at 720A, then 725A is skipped and no authentication condition is attached to the device action trigger.

Referring to FIG. 7A, at 730A, the user is prompted as to whether additional device action(s) are to be setup for the currently selected device. For example, the user can be prompted with screen 900G of FIG. 9G, whereby the user selects between populating more device actions for light bulb #6, 905G, or simply saving the current device action trigger(s) that have been configured for light bulb #6, 910G. If the user determines to setup additional device action(s) for the currently selected device at 730A, the process returns to 715A. Otherwise, the process advances to 735A, where the user is prompted as to whether the user wishes to select a new device for device action configuration. For example, the user can be prompted with screen 900H of FIG. 9H, whereby the user selects between selecting a new device for setting up one or more device action triggers, 905H, or else exiting the device action trigger configuration wizard, 910H. If the user determines to setup device action(s) with a new device, the process returns to 705A. Otherwise, the configured device action triggers (i.e., a device action and associated user action for triggering the device action) are pushed to one or more of the secondary processors 1 . . . N 545 which are responsible for monitoring for the user action(s) at least while the application processor 510 is in the low power mode, 740A. For example, the configured device action triggers can be pushed at 740A to a DSP that is configured to interact with a set of sensors, such as sensors 600C . . . 625C of FIG. 6C, that are configured to provide sensor feedback by which the user action(s) can be identified.

As will be appreciated, the specific order or sequence in which the blocks of FIG. 7A are presented is not intended to be indicative of a particular order-of-operations for these blocks. For example, the security prompt 720A and authentication condition 725A can be setup after the device selection of 705A before the device action triggers are actually configured at 715A. In another example, the security prompt 720A and authentication condition 725A can be setup before a device is even selected at 705A, with the authentication condition 725A being established as a default option for any device action triggers that are later configured for any selected device. Accordingly, FIG. 7A is generally considered to convey one particular example of a configuration tool or wizard for setting up device action triggers, whereby the specific order in which the wizard presents configuration options to the user is flexible.

As noted above, FIG. 7B illustrates an example of a discovery procedure performed by the secondary processors 1 . . . N 545 that can trigger execution of the process of FIG. 7A in accordance with an embodiment of the disclosure. Referring to FIG. 7B, the secondary processors 1 . . . N 545 perform a discovery procedure over a local wireless communications interface (e.g., Bluetooth, NFC, WiFi, etc.) to discover proximate devices (e.g., new IoT devices), 700B. In an example, the discovery procedure of 700B can be performed in coordination with the wireless communications interface 630C of FIG. 6C.

As mentioned above with respect to 700A of FIG. 7A, the discovery procedure of 700B can be implemented so as to discover devices that have already been onboarded to a local wireless network (e.g., IoT network, WLAN, etc.), devices that have not been onboarded to the local wireless network, or both.

In an example, with respect to 700B of FIG. 7B, a non-onboarded device may periodically transmit a broadcast frame via a local wireless communications interface (e.g., WiFi, Bluetooth, etc.) that identifies the non-onboarded device (e.g., via a Service Set Identifier (SSID), etc.) and indicates an associated network connectivity status (e.g., a list of local wireless networks with which the non-onboarded device is associated, if any, or an indication that the non-onboarded device is not onboarded to any wireless networks). The discovery procedure of 700B may include the secondary processor(s) 1 . . . N 545 monitoring the local wireless communications interface to detect these types of broadcast frames to discover nearby non-onboarded proximate devices. In a further example, certain local wireless networks implement onboarding protocols (e.g., ZigBee, Z-Wave, etc.) whereby any nearby device is automatically onboarded to a local wireless network. In such cases, detection of a non-onboarded device may be relatively rare when the mobile device 500 is in proximity of the local wireless network.

In another example, with respect to 700B of FIG. 7B, an onboarded device can be discovered based on a broadcast frame similar to the example above with respect to the non-onboarded device. Alternatively, the onboarded device can be discovered via a network-specific discovery protocol associated with the local wireless network for which the onboarded device is onboarded. For example, the network-specific discovery protocol can include direct polling (e.g., send out a message over an interface used by the local wireless network to request that any registered or onboarded device respond to the message), Internet Protocol (IP) scanning, User Datagram Protocol (UDP) handshaking, a Bonjour protocol (e.g., for Apple devices), etc.

When a proximate device is discovered at 700B, the secondary processors 1 . . . N 545 determine whether the user has already had an opportunity to configure device actions for the discovered proximate device via an earlier execution of the process of FIG. 7A, 705B (e.g., by checking whether any existing device action triggers are established for the discovered proximate device). If the secondary processors 1 . . . N 545 determine that the user has already been prompted to setup device action triggers for the discovered proximate device (e.g., the discovered proximate device was already identified to the user in screens 900A or 900B and the user did not opt to setup any device action triggers, or there are existing device action triggers setup for the discovered proximate device already), then the process returns to 700B and the secondary processors 1 . . . N 545 continue to perform the discovery procedure to identify proximate devices. Otherwise, the secondary processors 1 . . . N 545 send an alert (or notification) to the application processor 510, 710B. In an example, if the application processor 510 is in the active mode, the alert can simply be sent to the application processor 510 in response to the new device detection of 705B immediately (i.e., without having to wake up the application processor 510 from idle or lower power mode, because the application processor 510 is already awake). Further, if the application processor 510 is in the low power mode, the timing of the alert that is sent at 710B can be implemented in different ways. For example, the alert can be sent to the application processor 510 in response to the new device detection of 705B immediately while the application processor 510 is in the low power mode, such that the application processor 510 is woken up so as to take action to facilitate setup of new device action triggers for the newly detected device. In an alternative example, if the application processor 510 is in the low power mode, the alert can be queued for delivery by the secondary processors 1 . . . N 545 to the application processor 510 when the application processor 510 resumes the active mode to avoid waking up the application processor 510. As will be appreciated, queuing the alert for active mode delivery conserves power because the application processor 510 is permitted to continue in the low power mode, but the user may miss an opportunity to setup device action triggers if the application processor 510 resumes active mode only after the newly detected device from 705B is no longer proximate to the mobile device 500.

If the application processor 510 is in the low power mode, this prompts the application processor 510 to wake-up or transition to active mode, 715B. The user is then notified via the display screen 600A that a new proximate device has been detected and is available for device action trigger configuration, 720B. An example of the notification 720B is shown in screen 900I of FIG. 9I whereby two new configurable light bulbs are discovered, and the user is prompted to enter a device action configuration wizard, if desired. Another example of the notification 720B is shown in screen 900J of FIG. 9J whereby two new configurable light bulbs are discovered and a recommended user action (e.g., triple tap) and associated (or mapped) device action (e.g., toggle power) are proposed to the user with a YES button 905J and NO button 910J. If the user agrees with the proposed mapping between the device action and user action, the user simply presses the YES button 905J, and otherwise presses the NO button 910J (e.g., which can dismiss the prompt altogether or alternatively provide the user with an option to run the full device action configuration wizard).

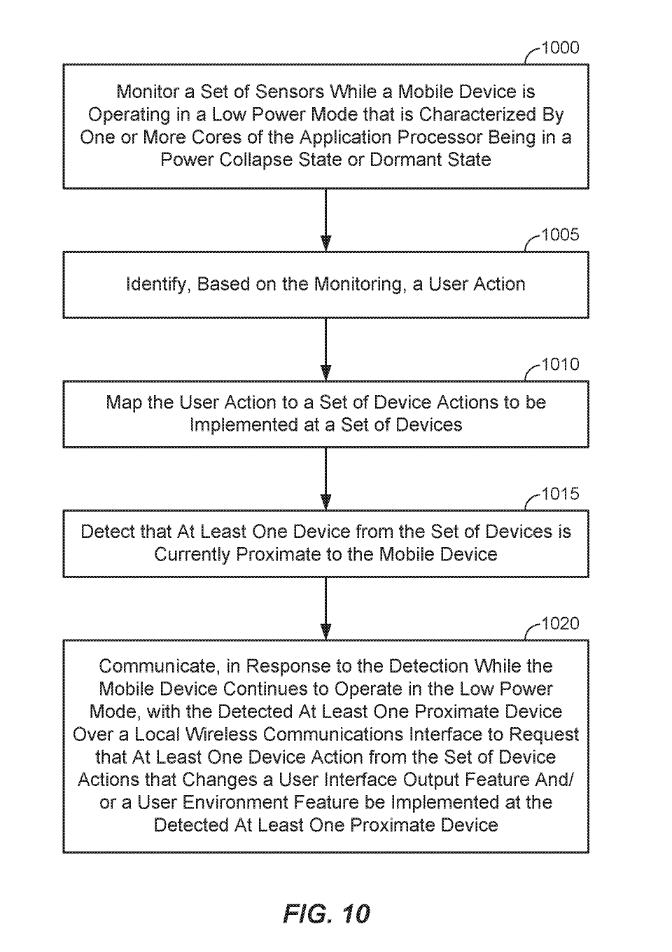

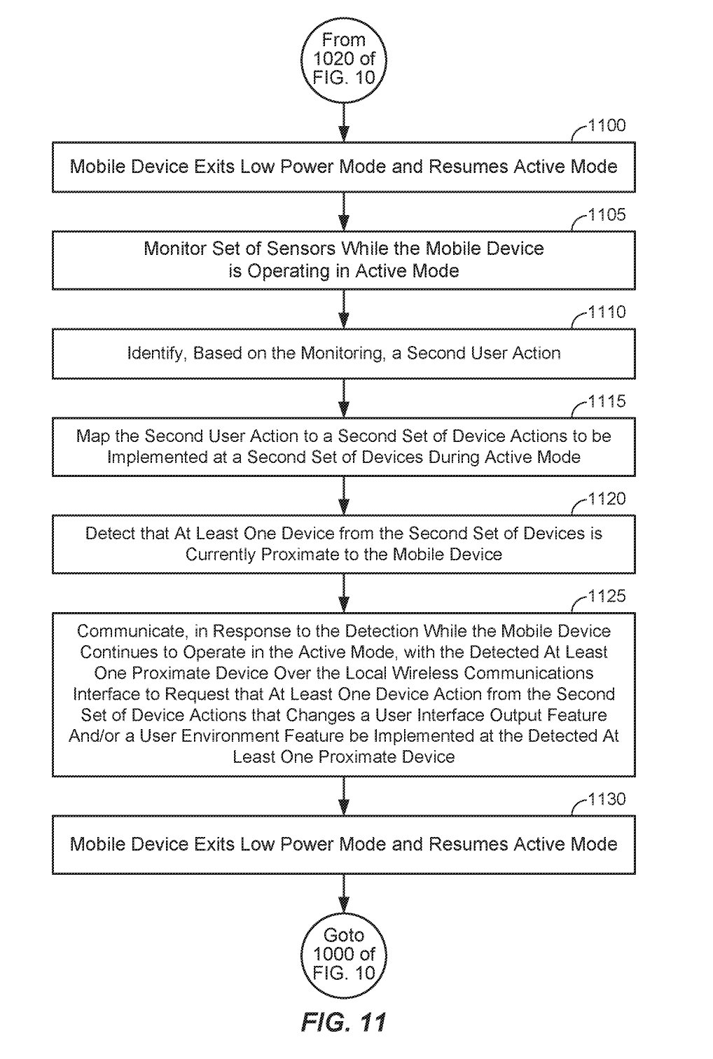

FIG. 10 illustrates a process of implementing at least one device action at a set of proximate devices in response to a detected user action in accordance with an embodiment of the disclosure. The process of FIG. 10 is implemented by one or more of the secondary processors 1 . . . N 545, such as a DSP that controls a set of sensors, while the application processor 510 is operating in the low power mode. Accordingly, the process of FIG. 10 is described as being performed by a particular secondary processor, with the understanding that multiple secondary processors could potentially be involved. Further, in the description of the process of FIG. 10 below, it is assumed that the process of FIG. 7A (or a similar process by which device actions are mapped to user actions) has already been executed, with the secondary processor being configured with the respective mappings. Accordingly, the secondary processor is configured to scan for particular user actions, which, upon detection, trigger their corresponding mapped device actions.

Referring to FIG. 10, the secondary processor monitors a set of sensors (e.g., one or more of sensors 600C-625C of FIG. 6C) while the mobile device 500 is operating in the low power mode, 1000. The secondary processor identifies, based on the monitoring, a user action (e.g., user lifts mobile device, user rotates mobile device, user taps a display screen of mobile device, user vertically or horizontally swipes his/her finger over the display screen of mobile device 500, etc.), 1005. In an embodiment, the user action can be a user-initiated action that is not solicited by the mobile device 500. For example, the user of the mobile device 500 need not be expressly asked to perform the user action, such as providing a confirmation that a particular action (e.g., pairing with a proximate device that was detected by the mobile device 500, etc.) is authorized. Rather, in at least one embodiment, the user action can be initiated by the user to achieve a user objective that originates at the user him/herself (e.g., the user thinks a display screen is too dark and on his/her own initiative performs the user action with the expectation that the user action will be detected and will cause the display screen to increase its brightness level, etc.).

Referring to FIG. 10, the secondary processor maps the identified user action to a set of device actions to be implemented at a set of devices, 1010. In an example, the mapping that occurs at 1010 can be based on the configured device action triggers that are pushed to the secondary processor(s) at 740A of FIG. 7A. The secondary processor detects that at least one device from the set of devices is currently proximate to the mobile device 500, 1015. In an example, the detection of 1015 can be based upon local wireless signals exchanged via the wireless communications interface 630C, either in response to the mapping operation of 1010 and/or the identifying of 1005, or alternatively at an earlier (but recent) point in time.

The secondary processor communicates, in response to the detection of 1015 while the mobile device 500 continues to operate in the low power mode, with the detected at least one proximate device over a local wireless communications interface (e.g., via the wireless communications interface 630C such as Bluetooth, NFC, WiFi, etc.) to request that at least one device action from the set of device actions that changes a user interface output feature (e.g., brightness, volume, toggling power on or off, a time zone of a displayed time on a clock, etc.) and/or a user environment feature (e.g., temperature or humidity in a region where the user is located, etc.) be implemented at the detected at least one proximate device, 1020. It will be appreciated that some device actions can implement a change that can be characterized as a change to both a user interface output feature and a user environment feature (e.g., a change in brightness output of a display screen may affect both the display screen as well as ambient light levels in a room, etc.). Table 1 (below) describes a number of different user actions that can be mapped to different types of device actions, as follows:

TABLE 1
Examples of Device Action(s) Triggered by User Actions

| Example | | Device | |
|---|---|---|---|
| # | User Action | Type(s) | Device Action(s) |
| #1 | Vertical | Light Bulb | Adjust Brightness Level Higher |
| [FIGS. | Swipe | | for “Up” Swipe and Lower for |
| 12A-12B] | on | | “Down” Swipe |
| | Touchscreen | | |
| #2 | Vertical | Light Bulb; | Light Bulb: Adjust Brightness |
| [FIGS. | Swipe | Speaker | Level Higher for “Up” Swipe and |
| 13A-13B] | on | | Lower for “Down” Swipe |
| | Touchscreen | | Speaker: Adjust Volume Level |
| | | | Higher for “Up” Swipe and |
| | | | Lower for “Down” Swipe |
| #3 | Triple Tap on | Light Bulb; | Light Bulb: Toggle Power On/Off |
| [FIGS. | Touchscreen | TV; | [Default Brightness Level = 50%] |
| 14A-14B] | | Speaker | Television: Toggle Power On/Off |
| | | | Speaker: Toggle Power On/Off |
| | | | [Default Volume Level = 70%] |
| #4 | Rotate | Speaker | Adjust Volume Level Higher for |
| [FIGS. | Mobile | | a Clockwise Rotation and Lower |
| 15A-15B] | Device | | for a Counter-Clockwise Rotation |
| #5 | Pick Up | Light Bulb | Turn Light Bulb On |
| [FIGS. | Mobile | | [Brightness Level = 10%] |
| 16A-16C] | Device in | | |
| | Low-Light | | |
| | Environment | | |
| #6 | Vertical | Vehicle | Adjust Fader Towards a Front- |
| | Swipe on | Speaker | Weighted Setting for “Up” Swipe |
| | Touchscreen | | and Towards a Rear-Weighted |
| | | | Setting for “Down” Swipe |
| #7 | Triple Tap on | HVAC | If Current Temperature >80 |
| | Touchscreen | System | Degrees Fahrenheit, Turn On Air |
| | with | | Conditioning; and |
| | Temperature | | If Current Temperature <65 |
| | Condition | | Degrees Fahrenheit, |
| | | | Turn On Heat |
| #8 | Triple Tap on | Clock(s) | Coordinate with Proximate |
| | Touchscreen | | Clock(s) to Update Time to |
| | with | | Current Time in a Current Time |
| | Location | | Zone |
| | Condition | | |

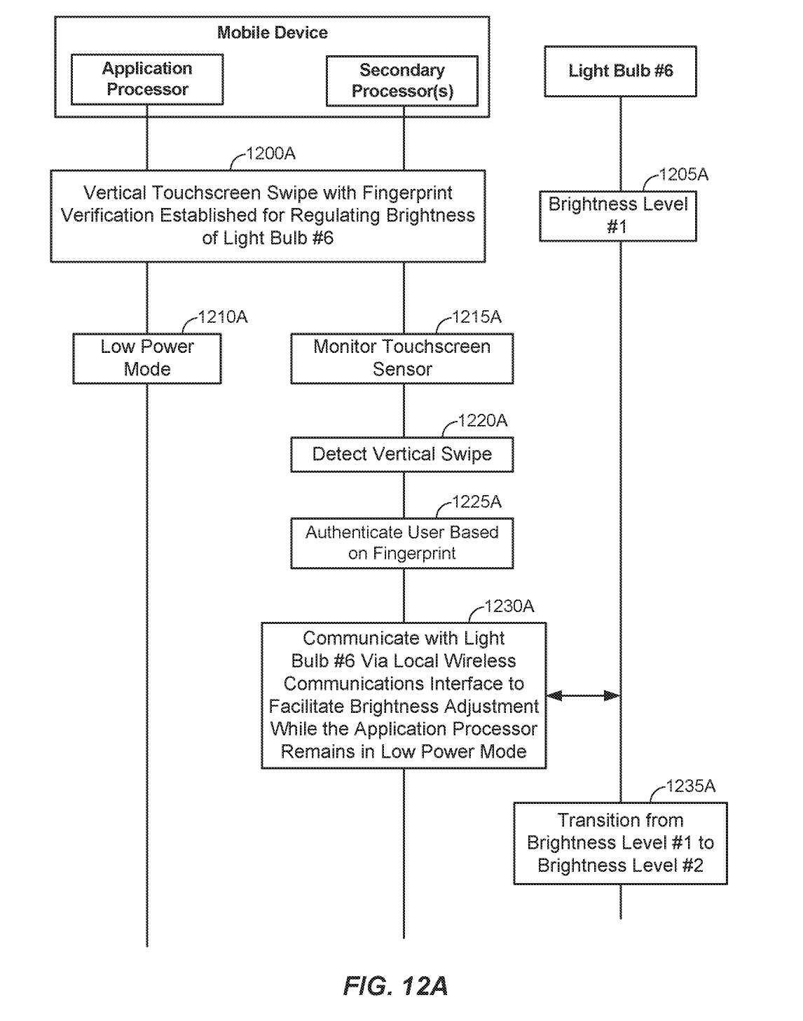

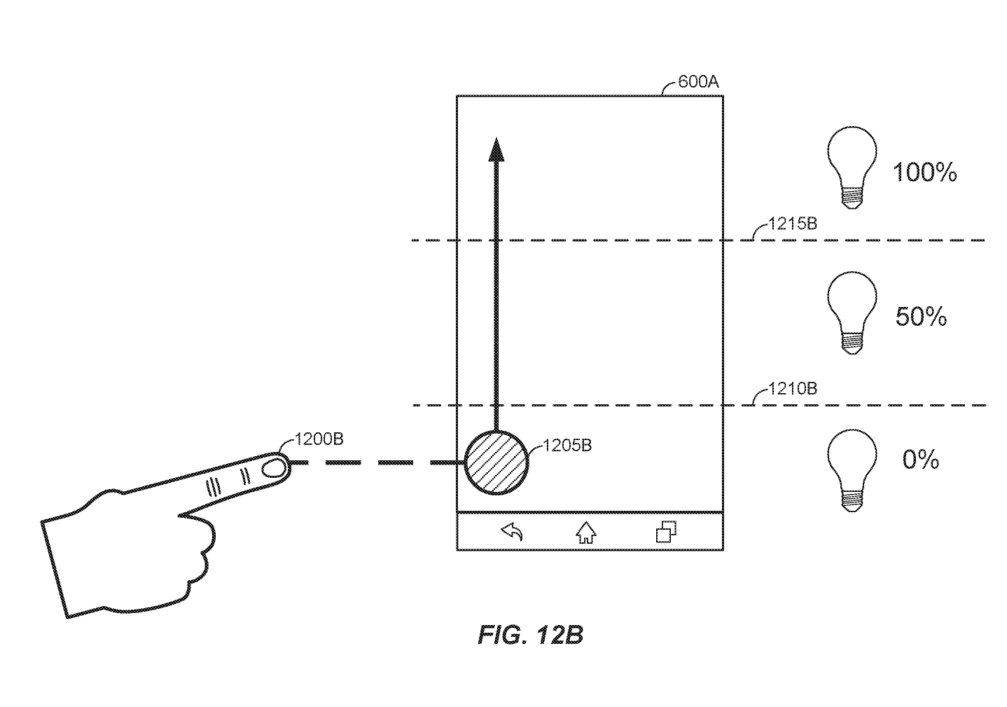

Examples #1-#5 in Table 1 (above) will become more clear upon review of the description of FIGS. 12A-16C below.

FIG. 11 illustrates an example continuation of the process of FIG. 10 in accordance with an embodiment of the disclosure. As will be appreciated, the user of the mobile device 500 may want at least some user actions to be mapped to corresponding device action(s) when the mobile device 500 is in active mode, instead of merely when the mobile device 500 is in the low power mode. However, it may be problematic to maintain user actions which are commonly performed during active mode as device action triggers. For example, vertical swiping of a touchscreen is a very common user input during active mode (e.g., a user will vertically swipe the touchscreen when running a browser application or e-book application to navigate to different portions of a web page or e-book, etc.). Other user actions that are not typically performed as a typical user input during active mode may be suitable as device action triggers during both low power mode and active mode. For example, triple-tapping the touchscreen of the mobile device 500 may occur from time to time during active mode, but in general is not a particularly common type of user input. With this in mind, the process of FIG. 11 shows that at least some user actions can maintain their status as device action triggers while the mobile device 500 is engaged in the active mode.

Referring to FIG. 11, at some point after 1020 of FIG. 10, the mobile device 500 exits the low power mode and resumes active mode, 1100. Accordingly, during the active mode, the mobile device 500 may be unlocked with the display screen 600A turned on, one or more mobile applications may be executed by the application processor 510, and so on. At this point, 1105-1125 generally correspond to 1000-1020 of FIG. 10, respectively (except that 1105-1125 are performed while the mobile device 500 is in the active mode as opposed to the low power mode, and some low power mode-only device action triggers may be disabled), and will not be described further for the sake of brevity. At 1130, the mobile device 500 exits the active mode and resumes the low power mode, and the process advances to 1000 of FIG. 10 where any low power mode-only device action triggers are re-enabled.

FIGS. 12A-16C illustrate various examples of user actions that are mapped to particular device actions in accordance with embodiments from the disclosure. In particular, the examples depicted in FIGS. 12A-16C correspond to the high-level descriptions in Examples #1-#5 of Table 1 (above).

Referring to FIG. 12A, assume that the process of FIG. 7A is executed, with the user action of a vertical touchscreen swipe with the authentication condition of a fingerprint verification being mapped to brightness level adjustments of light bulb #6 from the conference room 800 of FIG. 8, 1200A. At some later point in time, assume that the mobile device 500 is proximate to the light bulb #6 (e.g., the mobile device 500 is in the conference room 800), that the light bulb #6 is set to a first brightness level, 1205A, and the application processor 510 is operating in low power mode, 1210A. The secondary processor monitors the touchscreen sensor 610C while the application processor 510 is operating in the low power mode (e.g., the application processor 510 is asleep, the display screen 600A is turned off, etc.), 1215A. During the monitoring of 1215A, the secondary processor detects a vertical swipe on the touchscreen, 1220A. Using the biometric sensor 620C (e.g., a fingerprint sensor), the secondary processor authenticates the user as being an authorized user for initiating the device action trigger established at 1200A, 1225A. Without waking up the application processor 510, unlocking the mobile device 500, or turning on the display screen 600A, the secondary processor interacts, 1230A, with the wireless communications interface 630C in order to communicate with light bulb #6 via a local wireless communications interface (e.g., Bluetooth, NFC, WiFi, etc.) to facilitate a brightness level adjustment of light bulb #6 from the first brightness level to a second brightness level, 1235A, in accordance with the device action trigger established at 1200A.

FIG. 12B illustrates a real-world example of the process of FIG. 12A in accordance with an embodiment of the disclosure. In FIG. 12B, a user's finger 1200B initiates contact with the display screen 600A at contact point 1205B. Assume that the device action trigger is associated with different degrees of adjustment based on the degree of the vertical swipe. So, if the user's finger 1200B stops short of vertical threshold 1210B, light bulb #6 is turned off, if the user's finger 1200B moves past vertical threshold 1210B but short of vertical threshold 1215B, the brightness level is adjusted to 50%, and if the user's finger 1200B moves past vertical threshold 1215B, the brightness level of light bulb #6 is maxed out at 100%.

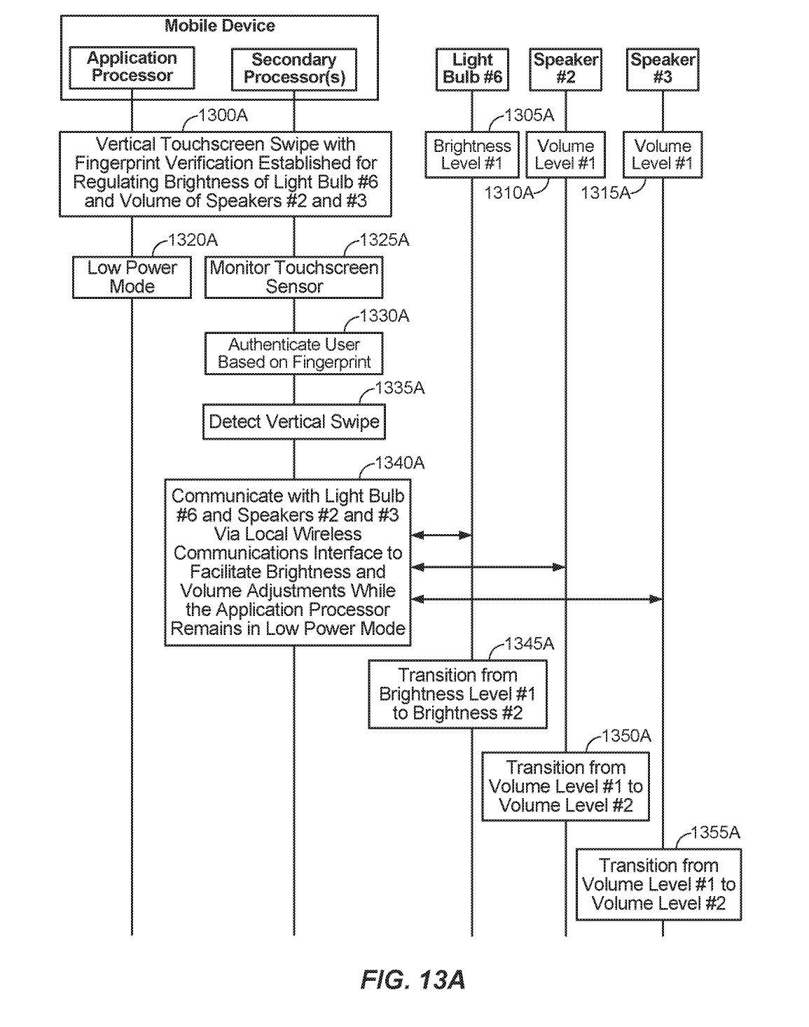

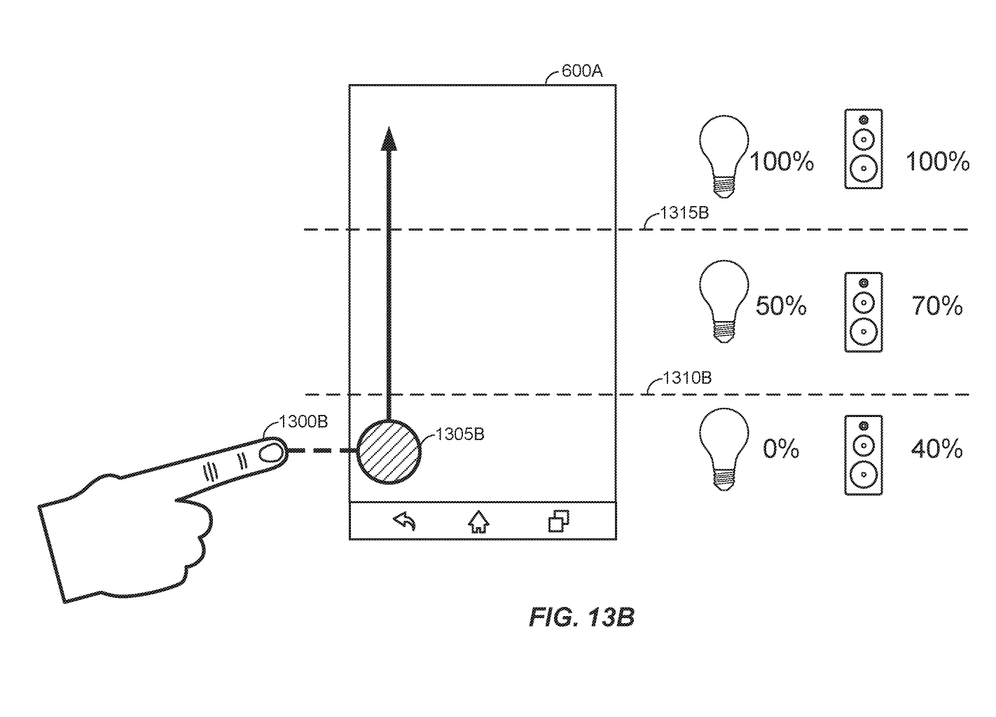

Referring to FIG. 13A, assume that the process of FIG. 7A is executed, with the user action of a vertical touchscreen swipe with the authentication condition of a fingerprint verification being mapped to volume level adjustments of speakers #2 and #3 as well as brightness level adjustments of light bulb #6 from the conference room 800 of FIG. 8, 1300A. At some later point in time, assume that the mobile device 500 is proximate to the speakers #2 and #3 and the light bulb #6 (e.g., the mobile device 500 is in the conference room 800), that the light bulb #6 is set to a first brightness level, 1305A, while speakers #2 and #3 are set to a first volume level, 1310A and 1315A, and the application processor 510 is operating in low power mode, 1320A. The secondary processor monitors the touchscreen sensor 610C while the application processor 510 is operating in the low power mode (e.g., the application processor 510 is asleep, the display screen 600A is turned off, etc.), 1325A.

In FIG. 12A, the authentication of 1225A is depicted as occurring after the vertical swipe is detected at 1220A. However, in another example, device action triggers can be authenticated before a triggering user action is actually detected. For example, the fingerprint of the user can be periodically verified and, so long as the user's fingerprint has been verified within a threshold period of time when a user action is actually detected, the user action can be immediately authenticated without the need for a separate authentication verification. With this in mind, during the monitoring of 1325A, the secondary processor uses the biometric sensor 620C (e.g., a fingerprint sensor) to authenticate the user as being an authorized user for initiating the device action trigger established at 1300A, 1330A. At this point, the vertical swipe has not actually been detected yet, so the authentication of 1330A does not result in the device action actually being implemented at this point. Next, assume that the secondary processor detects a vertical swipe on the touchscreen within the threshold period of time after the authentication of 1330A, 1335A. Without waking up the application processor 510, unlocking the mobile device 500 or turning on the display screen 600A, the secondary processor interacts, 1340A, with the wireless communications interface 630C in order to communicate with the speakers #2 and #3 and the light bulb #6 via a local wireless communications interface (e.g., Bluetooth, NFC, WiFi, etc.) to facilitate a brightness level adjustment of light bulb #6 from the first brightness level to a second brightness level, 1345A, and also to facilitate a volume level adjustment of speakers #2 and #3 from the first volume level to a second volume level, 1350A and 1355A, in accordance with the device action trigger established at 1300A. Further, it will be appreciated that for any of the scenarios depicted in FIGS. 12A-16C where authentication is required, the authentication condition can be verified in response to the user action being detected (e.g., as in FIG. 12A) or prior to the user action being detected (e.g., as in FIG. 13A).

FIG. 13B illustrates a real-world example of the process of FIG. 13A in accordance with an embodiment of the disclosure. In FIG. 13B, a user's finger 1300B initiates contact with the display screen 600A at contact point 1305B. Assume that the device action trigger is associated with different degrees of adjustment based on the degree of the vertical swipe. So, if the user's finger 1300B stops short of vertical threshold 1310B, light bulb #6 is turned off while speakers #2 and #3 are adjusted to a volume level of 40%, if the user's finger 1300B moves past vertical threshold 1310B but short of vertical threshold 1315B, the brightness level is adjusted to 50% while speakers #2 and #3 are adjusted to a volume level of 70%, and if the user's finger 1300B moves past vertical threshold 1315B, the brightness level of light bulb #6 is maxed out at 100% and volume level of speakers #2 and #3 is also maxed out at 100%.

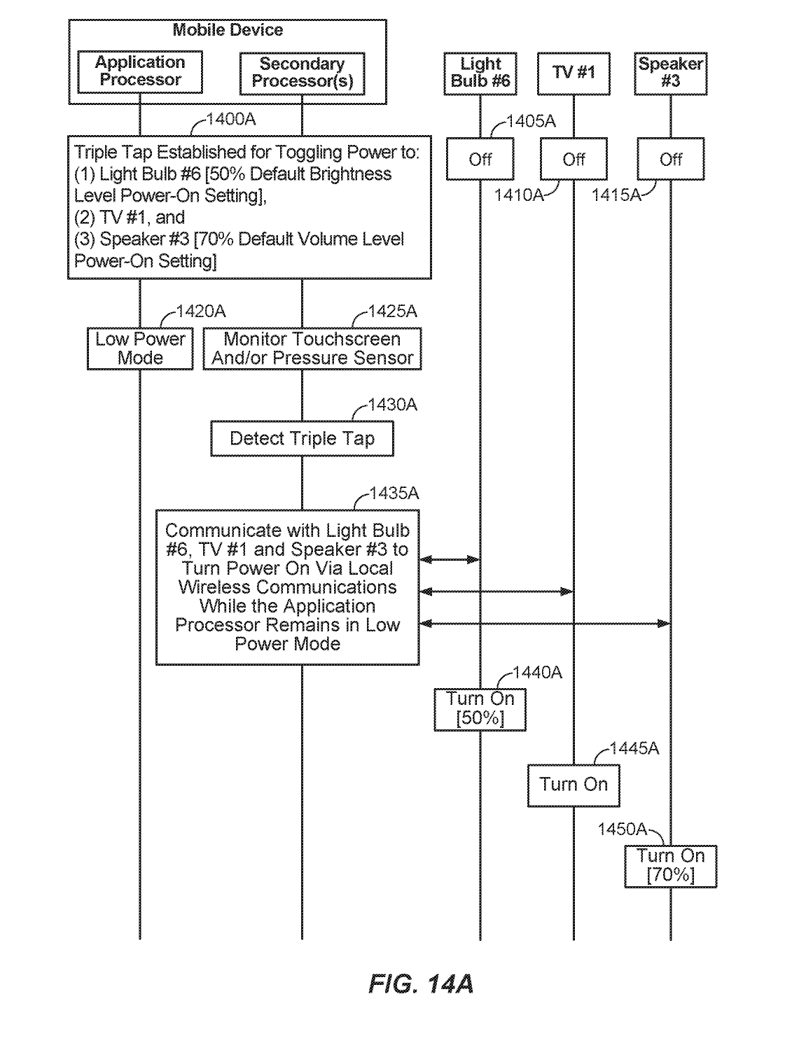

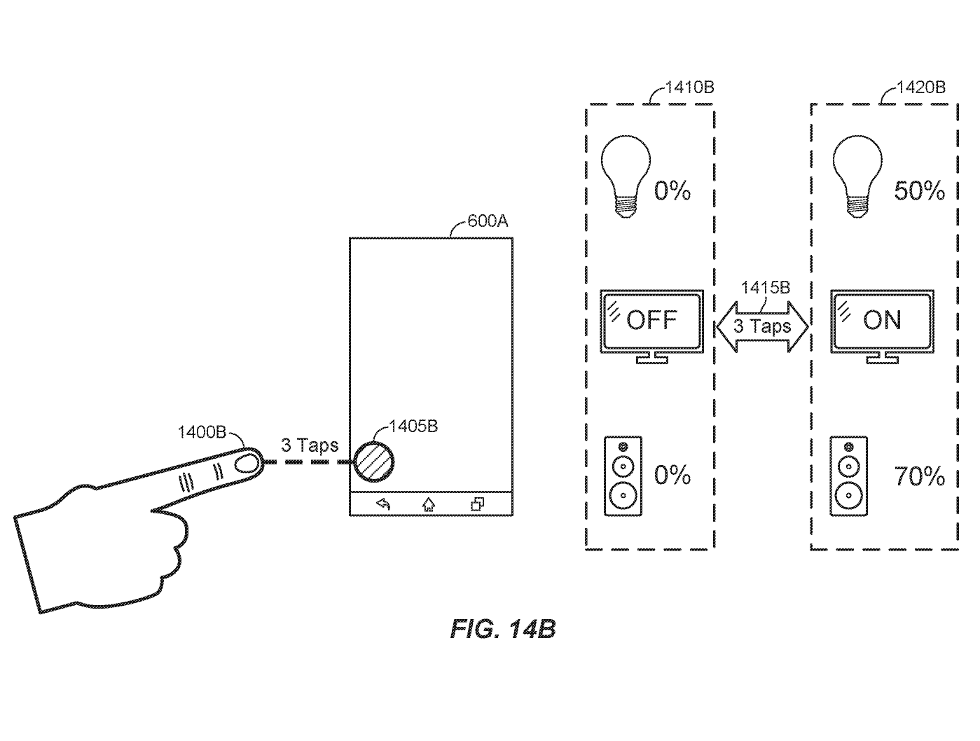

Referring to FIG. 14A, assume that the process of FIG. 7A is executed, with the user action of a triple-tap (at any location of the display screen 600A) for any user (i.e., no specified authentication condition) being mapped to a toggle power device action for light bulb #6, television #1 and speaker #3, 1400A. In an example, a default brightness level for light bulb #6 when power is turned on may be 50% while a default volume level for speaker #3 when power is turned on may be 70%. In another example, instead of default brightness and volume levels, the respective brightness and volume levels of light bulb #6 and speaker #3 may be to return to an associated level that was being used prior to the last time power was turned off. At some later point in time, assume that the mobile device 500 is proximate to the light bulb #6, television #1 and speaker 3 (e.g., the mobile device 500 is in the conference room 800), that the light bulb #6, television #1 and speaker 3 are each turned off, 1405A, 1410A and 1415A, and the application processor 510 is operating in low power mode, 1420A. The secondary processor monitors the touchscreen sensor 610C and/or the pressure sensor 625C while the application processor 510 is operating in the low power mode (e.g., the application processor 510 is asleep, the display screen 600A is turned off, etc.), 1425A. During the monitoring of 1425A, the secondary processor detects a triple-tap on the touchscreen, 1430A. Without waking up the application processor 510, unlocking the mobile device 500 or turning on the display screen 600A, the secondary processor interacts with the wireless communications interface 630C in order to communicate with the light bulb #6, television #1 and speaker #3 via a local wireless communications interface (e.g., Bluetooth, NFC, WiFi, etc.) to facilitate a toggle power device action (i.e., in this case, to turn on each of these devices), 1435A. In response to the communication of 1435A, light bulb #6, television #1 and speaker #3 each turn on, 1440A, 1445A and 1450A. In an example, light bulb #6 and speaker #3 turn on at their respective default levels (e.g., brightness level=50% for light bulb #6 and volume level=70% for speaker #3).

FIG. 14B illustrates a real-world example of the process of FIG. 14A in accordance with an embodiment of the disclosure. In FIG. 14B, a user's finger 1400B triple-taps the display screen 600A at contact point 1405B. Prior to the triple-tap at contact point 1405B, assume that each of the light bulb #6, television #1 and speaker #3 are in an off state, as shown in 1410B. The triple-tap detected at contact point 1405B while the mobile device 500 is in the low power mode functions to transition, 1415B, each of the light bulb #6, television #1 and speaker #3 to an on state, as shown in 1420B. Each time the user triple-taps the display screen 600A, the light bulb #6, television #1 and speaker #3 are toggled between the states depicted in 1420B and the states depicted in 1410B, such that the user can turn each of these devices on or off by triple-tapping the display screen 600A.

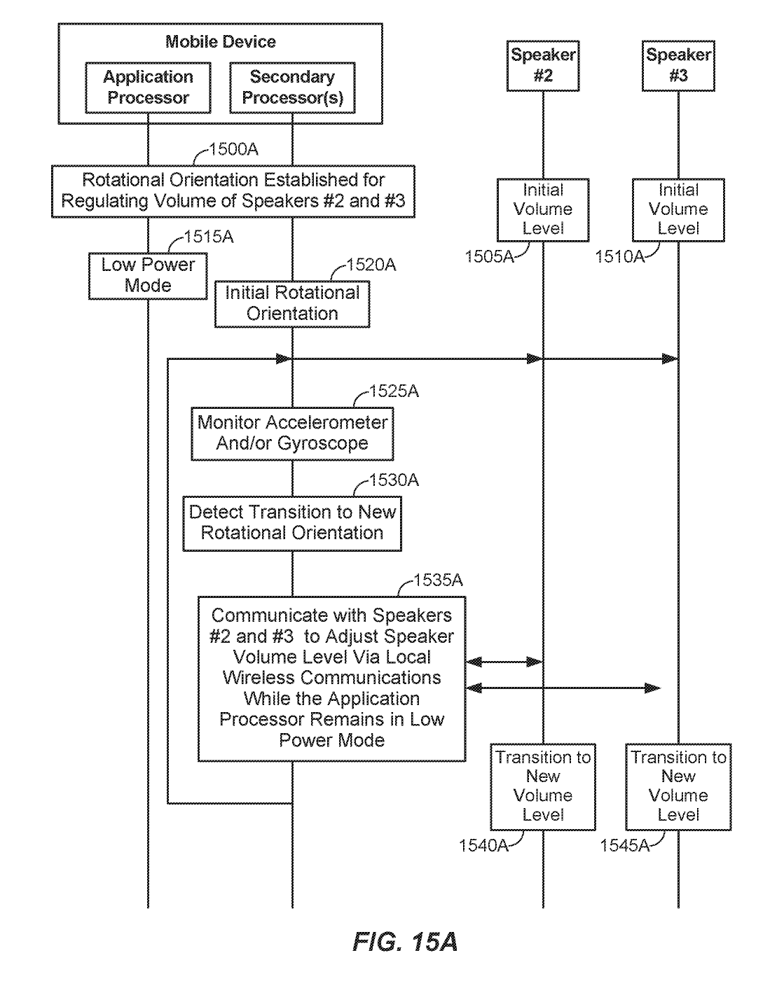

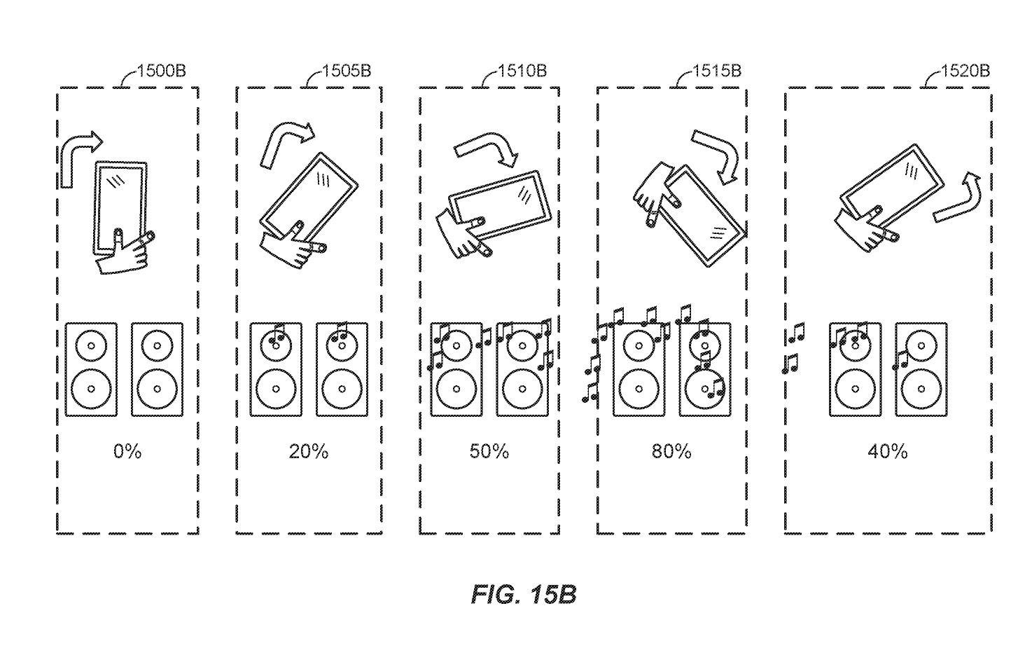

Referring to FIG. 15A, assume that the process of FIG. 7A is executed, with the user action of a device rotation for any user (i.e., no specified authentication condition) being mapped to an adjust volume device action for speaker #2 and speaker #3, 1500A. In particular, assume that the adjust volume device action increases the volume level when the mobile device 500 is rotated in a clockwise direction and decreases the volume level when the mobile device 500 is rotated in a counter-clockwise direction. At some later point in time, assume that the mobile device 500 is proximate to speaker #2 and speaker #3 (e.g., the mobile device 500 is in the conference room 800), that speaker #2 and speaker #3 are set to an initial volume level, 1505A and 1510A, the application processor 510 is operating in low power mode, 1515A, and the mobile device 500 is at an initial rotation orientation (e.g., the mobile device 500 is placed on its back facing upwards, the mobile device 500 is propped up on a stand or support structure, the mobile device 500 is being held in the user's hand in a landscape orientation relative to the user's face, etc.), 1520A. The secondary processor monitors the accelerometer 600C and/or gyroscope 605C while the application processor 510 is operating in the low power mode (e.g., the application processor 510 is asleep, the display screen 600A is turned off, etc.), 1525A. During the monitoring of 1525A, the secondary processor detects a transition of the mobile device 500 to a new rotational orientation, 1530. Without waking up the application processor 510, unlocking the mobile device 500 or turning on the display screen 600A, the secondary processor interacts with the wireless communications interface 630C in order to communicate with speaker #2 and speaker #3 via a local wireless communications interface (e.g., Bluetooth, NFC, WiFi, etc.) to facilitate a volume level adjustment, 1535A. In response to the communication of 1535A, speaker #2 and speaker #3 each transition to a new volume level, 1540A and 1545A.

FIG. 15B illustrates a real-world example of the process of FIG. 15A in accordance with an embodiment of the disclosure. In FIG. 15B, the mobile device 500 is held at a first rotational orientation while speakers #2 and #3 are turned off (volume level=0%), 1500B. Next, the user begins to rotate the mobile device 500 in a clockwise direction which results in the speakers #2 and #3 increasing their volume level to 20%, 1505B. The user then further rotates the mobile device 500 in the clockwise direction which results in the speakers #2 and #3 increasing their volume level to 50%, 1510B. The user then further rotates the mobile device 500 in the clockwise direction which results in the speakers #2 and #3 increasing their volume level to 80%, 1515B. At this point, the user determines that the volume level is too high, and the user rotates the mobile device 500 in a counter-clockwise direction that lowers the volume level of speakers #2 and #3 down to 40%, 1520B.

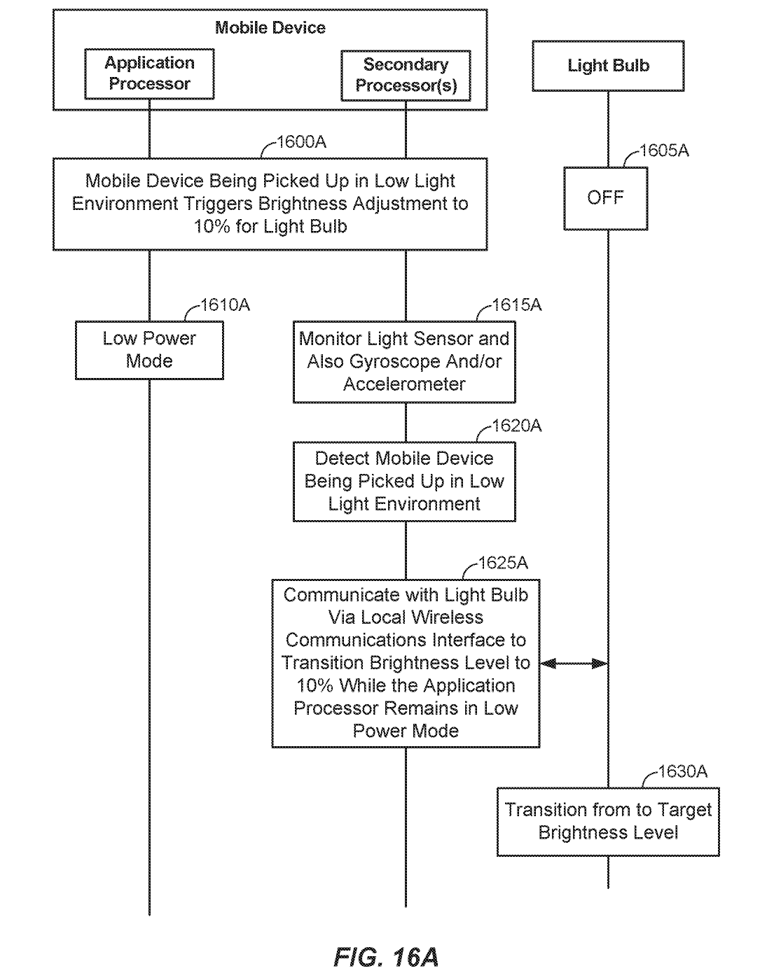

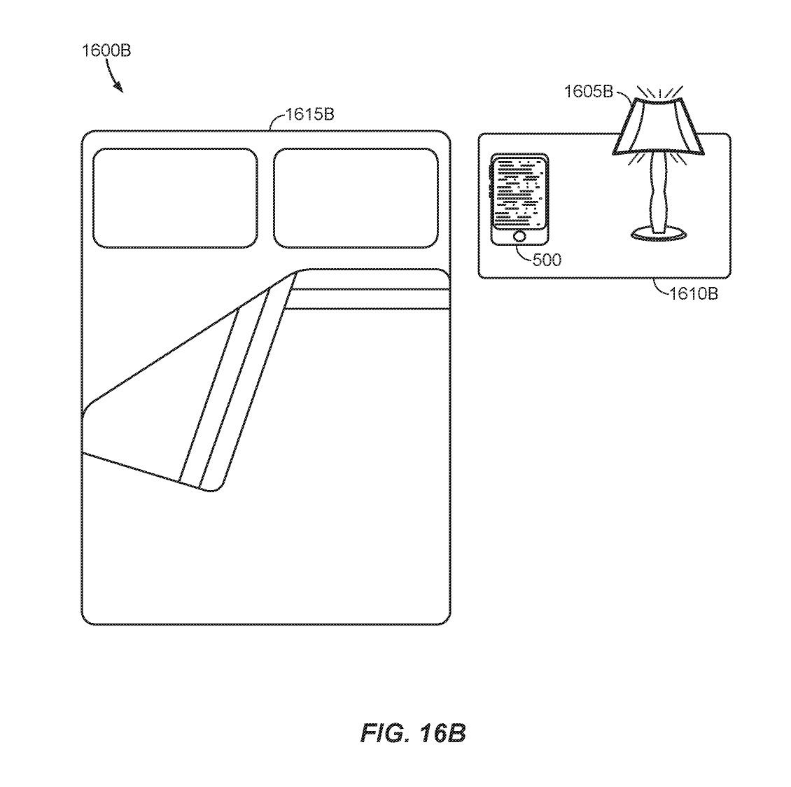

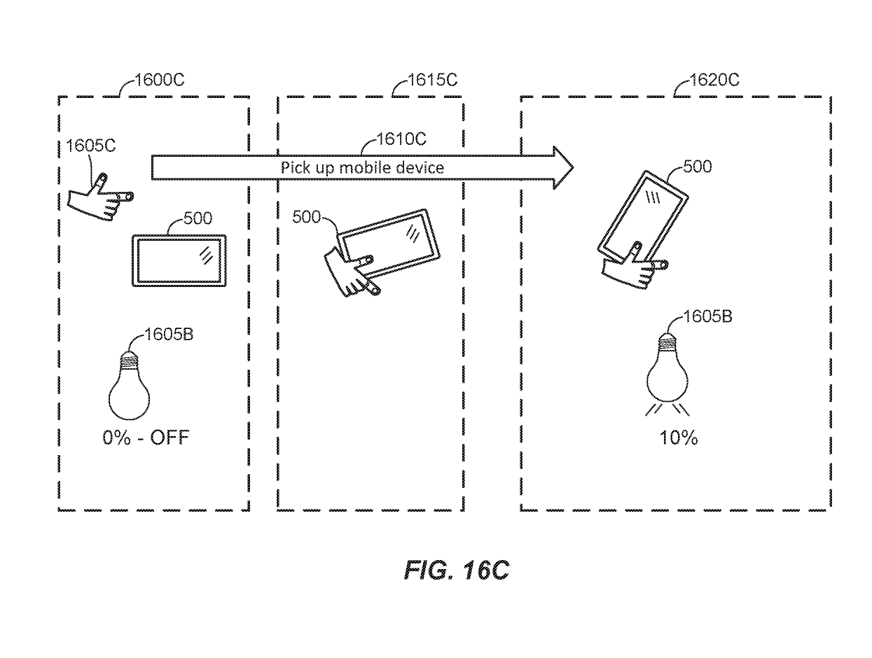

Referring to FIG. 16A, assume that the process of FIG. 7A is executed, with the user action of the mobile device 500 being picked-up in a low light environment for any user (i.e., no authentication condition) being mapped to brightness level adjustments of (as depicted in FIG. 16B) a light bulb 1605B that is positioned on top of a night-stand 1610B in a bedroom 1600B that further includes a bed 1615B, 1600A. As will be appreciated, a user picking up his/her mobile device in a low-light environment (especially in a bedroom) can be an indication that the user has just woken up, which is an indication that the user may desire a gradual transition to a higher light environment (e.g., so that the user can navigate to a bathroom or bedroom closet, etc.). However, if the user is taking a nap in the middle of the day, the user may not require light bulbs to increase their light output to transition the bedroom 1600B to a brighter environment, so the low light environment is also a condition on the device action in this case.

At some later point in time, assume that the mobile device 500 is proximate to the light bulb 1605B (e.g., the mobile device 500 is in the bedroom 1600B), that the light bulb 1605B is off (brightness level=0%), 1605A, and the application processor 510 is operating in low power mode, 1610A. The secondary processor monitors the accelerometer 600C and/or gyroscope 605C to detect when the mobile device 500 is picked up and also monitors the light sensor 615C to verify the low light environment condition while the application processor 510 is operating in the low power mode (e.g., the application processor 510 is asleep, the display screen 600A is turned off, etc.), 1615A. During the monitoring of 1615A, the secondary processor detects the mobile device 500 being picked up in the low light environment, 1620A. Without waking up the application processor 510, unlocking the mobile device 500 or turning on the display screen 600A, the secondary processor interacts, 1625A, with the wireless communications interface 630C in order to communicate with light bulb 1605B via a local wireless communications interface (e.g., Bluetooth, NFC, WiFi, etc.) to facilitate a brightness level adjustment of light bulb 1605B to a brightness level (e.g., brightness level=10%), 1630A, in accordance with the device action trigger established at 1600A.

FIG. 16C illustrates a real-world example of the process of FIG. 16A in accordance with an embodiment of the disclosure. In FIG. 16C, state 1600C shows mobile device 500 being placed face-up on a surface while the light bulb 1605B is off and the user's hand 1605C begins to reach towards the mobile device 500. State 1615C shows the mobile device 500 begin to move as the user's hand 1605C grasps the mobile device 500 and starts to lift, 1610C. State 1620C shows the mobile device 500 being lifted sufficiently so that a lift detection is made based on feedback from the accelerometer 600C and/or gyroscope 605C, with the light bulb 1605B being turned on at the target brightness level of 10%.

Referring now to Example #6 from Table 1 (above), it will be appreciated that users generally have access to some mechanisms to directly control certain car infotainment features (e.g., a volume knob to regulate master volume, a tuner knob to change an AM or FM radio frequency, etc.), while modifying other car infotainment settings (e.g., bass or treble audio configurations, relative volume of turn-by-turn navigation commands to music volume, etc.) requires more complex menu navigation. Also, most controls for the car infotainment system are generally only accessible at the front of the car (i.e., to the driver or front-seat passenger). In Example #6 from Table 1 (above), the mobile device 500 can be located anywhere inside the vehicle (or even outside the vehicle in relatively close proximity) and can connect to the car infotainment system so as to control one or more features of the car infotainment system. In particular, Example #6 from Table 1 (above) relates to a scenario where the mobile device 500, after connecting to the car infotainment system, can operate in low power mode while permitting the user to modify Fader settings of the vehicle's audio system via vertical swipes, so that the volume of the vehicle's audio system can be selectively biased towards the front or rear of the vehicle. Of course, other parameters (e.g., regulating master volume, selecting an alternate navigation route in an in-vehicle GPS system, etc.) can also be controlled in a similar manner and/or in response to other types of user actions.

Referring now to Example #7 from Table 1 (above), triple-tapping the touchscreen of the mobile device 500 can trigger a variable action related to a proximate Heating, Venting and Air Conditioning (HVAC) system based on temperature. In particular, when a triple-tap is detected by the touchscreen sensor 610C and the thermometer 635C indicates that a current temperature is higher than 80 degrees Fahrenheit, the mobile device 500 coordinates with the HVAC system to turn on air conditioning (or lower a target set-point temperature of the HVAC system) so as to lower the environmental temperature. Further, when a triple-tap is detected by the touchscreen sensor 610C and the thermometer 635C indicates that a current temperature is lower than 65 degrees Fahrenheit, the mobile device 500 coordinates with the HVAC system to turn on heat (or increase a target set-point temperature of the HVAC system) so as to increase the environmental temperature. In an example, a triple-tap detected in an intermediate range (e.g., 65-80 degrees Fahrenheit) can result in the user being prompted to indicate a desired HVAC system adjustment.

Referring now to Example #8 from Table 1 (above), triple-tapping the touchscreen of the mobile device 500 can trigger a variable action related to one or more proximate clocks based on location. In particular, when a triple-tap is detected by the touchscreen sensor 610C and signal measurement data from the SPS receiver 640C indicates that a current location of the mobile device 500 uses Eastern Standard Time (EST), the mobile device 500 coordinates with one or more proximate clocks to change their time setting (if necessary) to reflect EST time. Further, when a triple-tap is detected by the touchscreen sensor 610C and signal measurement data from the SPS receiver 640C indicates that a current location of the mobile device 500 uses Pacific Standard Time (PST), the mobile device 500 coordinates with one or more proximate clocks to change their time setting (if necessary) to reflect PST time. In this case, a user can travel with a preferred clock with the expectation that the preferred clock's timing will be updated in a dynamic manner to reflect local timing.

Additional details that relate to the aspects and embodiments described herein are described and illustrated in Appendix A attached hereto, the contents of which are expressly incorporated herein by reference in their entirety as part of this disclosure.

Those skilled in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Further, those skilled in the art will appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted to depart from the scope of the present disclosure.

The various illustrative logical blocks, modules, and circuits described in connection with the aspects disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices (e.g., a combination of a DSP and a microprocessor, a plurality of microprocessors, one or more microprocessors in conjunction with a DSP core, or any other such configuration).

The methods, sequences and/or algorithms described in connection with the aspects disclosed herein may be embodied directly in hardware, in a software module executed by a processor, or in a combination of the two. A software module may reside in RAM, flash memory, ROM, EPROM, EEPROM, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in an IoT device. In the alternative, the processor and the storage medium may reside as discrete components in a user terminal.

In one or more exemplary aspects, the functions described herein may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, DSL, or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes CD, laser disc, optical disc, DVD, floppy disk and Blu-ray disc where disks usually reproduce data magnetically and/or optically with lasers. Combinations of the above should also be included within the scope of computer-readable media.

While the foregoing disclosure shows illustrative aspects of the disclosure, it should be noted that various changes and modifications could be made herein without departing from the scope of the disclosure as defined by the appended claims. The functions, steps and/or actions of the method claims in accordance with the aspects of the disclosure described herein need not be performed in any particular order. Furthermore, although elements of the disclosure may be described or claimed in the singular, the plural is contemplated unless limitation to the singular is explicitly stated.

What is claimed is:

1. A method of operating a mobile device that is equipped with an application processor configured to execute a High Level Operating System (HLOS) of the mobile device and a set of secondary processors configured to control a set of sensors coupled to the mobile device, comprising:
monitoring the set of sensors while the mobile device is operating in a low power mode that is characterized by one or more cores of the application processor being in a dormant state or a power collapse state;
identifying, based on the monitoring, a user action;
mapping the user action to a set of device actions to be implemented at a set of devices;
detecting that at least one device from the set of devices is currently proximate to the mobile device; and
communicating, in response to the detecting while the mobile device continues to operate in the low power mode, with the detected at least one proximate device over a local wireless communications interface to request that at least one device action from the set of device actions that changes a user interface output feature and/or a user environment feature be implemented at the detected at least one proximate device.

2. The method of claim 1, wherein the identifying identifies the user action without solicitation by the mobile device.

3. The method of claim 1, wherein the detecting is triggered in response to the identifying.

4. The method of claim 1, wherein the low power mode is further characterized by one or more of:
(i) the mobile device being in a locked state,
(ii) a display screen of the mobile device being off,
(iii) all cores of the application processor being in the dormant state or the power collapse state,
(iv) at least one and less than all cores of the application processor being in the dormant state or the power collapse state,
(v) client applications being executed by the application processor at fixed times,
(vi) non-crucial hardware that is not used to perform the monitoring, the identifying, the mapping, the detecting and/or the communicating being in the dormant state or the power collapse state, or
(vii) any combination thereof.

5. The method of claim 4, wherein the non-crucial hardware includes one or more cameras and/or a graphical processing unit (GPU) of the mobile device.

6. The method of claim 1, wherein the mobile device exits the low power mode and resumes active mode, the active mode being characterized by the one or more cores of the application processor being active, further comprising:
monitoring the set of sensors while the mobile device is operating in the active mode;
identifying, based on the monitoring, a given user action;
mapping the given user action to a given set of device actions to be implemented at a given set of devices irrespective of whether the given user action is detected during the active mode or the low power mode;
second detecting that at least one device from the given set of devices is currently proximate to the mobile device; and
communicating, while the mobile device continues to operate in the active mode in response to the second detecting, with the second detected at least one proximate device over the local wireless communications interface to request that at least one new device action from the given set of device actions that changes a given user interface output feature and/or a given user environment feature be implemented at the second detected at least one proximate device.

7. The method of claim 1, further comprising:
displaying a list of proximate devices;
receiving a selection of a given proximate device in response to the displaying;
determining device capabilities of the selected proximate device; and
interacting with a user to develop a mapping between one or more device actions and a given user action that is detectable by the set of sensors at the mobile device while the mobile device is operating in the low power mode,
wherein the mapping is based on prior execution of the displaying, the receiving, the determining and the interacting,
wherein the selected proximate device is included among the set of devices,
wherein the given user action corresponds to the user action, and
wherein the one or more device actions is included among the set of device actions.

8. The method of claim 7, further comprising:
discovering a new device that is not yet associated with any user action that is configured to trigger any device action at the new device,
wherein the displaying occurs in response to the discovering.

9. The method of claim 7, wherein the set of devices to which the set of device actions are mapped are each onboarded devices that belong to a local wireless network that uses the local wireless communications interface, further comprising:
determining, in response to the receiving, that the selected proximate device is not yet onboarded to the local wireless network; and
facilitating the selected proximate device to be onboarded to the local wireless network in response to the determining.

10. The method of claim 1, wherein the set of secondary processors is configured to execute a Real-Time Operating System (RTOS).

11. The method of claim 1, further comprising:
verifying whether an authentication condition associated with the user action is satisfied,
wherein the communicating is performed only if the authentication condition is satisfied.

12. The method of claim 11, wherein the authentication condition is verification that a user making the user action is an authorized user.

13. The method of claim 11, wherein the authentication condition requires biometric verification of a user making the user action.

14. The method of claim 1, wherein the user action includes a user performing one or more of:
(i) vertically or horizontally swiping a display screen of the mobile device,
(ii) tapping on the display screen of the mobile device a threshold number of times,
(iii) rotating the mobile device,
(iv) picking up the mobile device in a low light environment, or
(v) any combination thereof.

15. The method of claim 1, wherein the set of device actions includes one or more of:
(i) adjusting a brightness level of a light bulb,
(ii) adjusting a volume level of a speaker,
(iii) adjusting one or more audio settings of an audio system;
(iv) toggling power on or off to the at least one proximate device,
(v) adjusting a temperature setting,
(vi) transitioning one or more clocks to a different time zone, or
(vii) any combination thereof.

16. The method of claim 1,
wherein the at least one proximate device includes a single proximate device, or
wherein the at least one proximate device includes multiple proximate devices.

17. The method of claim 1,
wherein the set of devices are Internet of Things (IoT) devices, and
wherein the local wireless communications interface is an IoT interface that is configured to communicate with the set of devices over an IoT network.

18. The method of claim 1, wherein the set of sensors includes one or more of:
an accelerometer,
(ii) a gyroscope,
(iii) a touchscreen sensor,
(iv) a light sensor,
(v) a biometric sensor,
(vi) a pressure sensor,
(vii) a microphone,
(viii) a thermometer,
(ix) a satellite positioning system (SPS) receiver, or
(x) any combination thereof.

19. A mobile device, comprising:
an application processor configured to execute a High Level Operating System (HLOS) of the mobile device; and
a set of secondary processors configured to control a set of sensors coupled to the mobile device,
wherein the set of secondary processors is configured to:
monitor the set of sensors while the mobile device is operating in a low power mode that is characterized by one or more cores of the application processor being in a dormant state or a power collapse state;
identify, based on the monitoring, a user action;
map the user action to a set of device actions to be implemented at a set of devices;
detect that at least one device from the set of devices is currently proximate to the mobile device; and
communicate, in response to the detection while the mobile device continues to operate in the low power mode, with the detected at least one proximate device over a local wireless communications interface to request that at least one device action from the set of device actions that changes a user interface output feature and/or a user environment feature be implemented at the detected at least one proximate device.

20. A non-transitory computer-readable medium containing instructions stored thereon, which, when executed by a mobile device that is equipped with an application processor configured to execute a High Level Operating System (HLOS) of the mobile device and a set of secondary processors configured to control a set of sensors coupled to the mobile device, cause the mobile device to perform operations, the operations comprising:
at least one instruction to cause the mobile device to monitor the set of sensors while the mobile device is operating in a low power mode that is characterized by one or more cores of the application processor being in a dormant state or a power collapse state;
at least one instruction to cause the mobile device to identify, based on the monitoring, a user action;
at least one instruction to cause the mobile device to map the user action to a set of device actions to be implemented at a set of devices;
at least one instruction to cause the mobile device to detect that at least one device from the set of devices is currently proximate to the mobile device; and
at least one instruction to cause the mobile device to communicate, in response to the detection while the mobile device continues to operate in the low power mode, with the detected at least one proximate device over a local wireless communications interface to request that at least one device action from the set of device actions that changes a user interface output feature and/or a user environment feature be implemented at the detected at least one proximate device.
